(19) United States
(12) Patent Application Publication
(10) Pub. No.: US 2026/0244871 A1
(43) Pub. Date: Aug. 20, 2026

(54) Sleep, Maintenance, and Temporal Manifold Rewriting in Persistent Cognitive Machines

(71) Applicant: AtomBeam Technologies Inc., Moraga, CA (US)

(72) Inventor: Brian Galvin, Silverdale, WA (US)

(21) Appl. No.: 19/645,854

(22) Filed: Apr. 13, 2026

Related U.S. Application Data
(63) Continuation-in-part of application No. 19/550,709, filed on Feb. 26, 2026.
Application No. 19/550,709 is a continuation-in-part of application No. 19/548,024, filed on Feb. 24, 2026.
Application No. 19/548,024 is a continuation-in-part of application No. 19/546,407, filed on Feb. 22, 2026.
Application No. 19/546,407 is a continuation-in-part of application No. 19/534,677, filed on Feb. 9, 2026, now Pat. No. 12,651,010.
(63) Continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/901,793, filed on Oct. 19, 2025.
(60) Provisional application No. 63/941,637, filed on Dec. 15, 2025.
(60) Provisional application No. 63/941,642, filed on Dec. 15, 2025.
(60) Provisional application No. 63/965,251, filed on Jan. 21, 2026.
(60) Provisional application No. 63/965,273, filed on Jan. 21, 2026.
(60) Provisional application No. 63/965,321, filed on Jan. 21, 2026.
(60) Provisional application No. 63/965,242, filed on Jan. 21, 2026.
(60) Provisional application No. 63/966,904, filed on Jan. 23, 2026.
(60) Provisional application No. 63/966,944, filed on Jan. 23, 2026.
(60) Provisional application No. 63/966,955, filed on Jan. 23, 2026.
(60) Provisional application No. 63/967,705, filed on Jan. 25, 2026.
(60) Provisional application No. 63/967,707, filed on Jan. 25, 2026.
(60) Provisional application No. 63/967,710, filed on Jan. 25, 2026.
(60) Provisional application No. 63/967,713, filed on Jan. 25, 2026.
(60) Provisional application No. 63/967,715, filed on Jan. 25, 2026.
(60) Provisional application No. 63/967,718, filed on Jan. 25, 2026.
(60) Provisional application No. 63/967,721, filed on Jan. 25, 2026.
(60) Provisional application No. 63/967,726, filed on Jan. 25, 2026.
(60) Provisional application No. 63/968,152, filed on Jan. 26, 2026.
(60) Provisional application No. 63/975,311, filed on Feb. 3, 2026.
(60) Provisional application No. 63/975,314, filed on Feb. 3, 2026.
(60) Provisional application No. 63/976,098, filed on Feb. 4, 2026.
(60) Provisional application No. 63/976,101, filed on Feb. 4, 2026.
(60) Provisional application No. 63/976,103, filed on Feb. 4, 2026.
(60) Provisional application No. 63/976,109, filed on Feb. 4, 2026.
(60) Provisional application No. 63/976,115, filed on Feb. 4, 2026.
(60) Provisional application No. 63/978,340, filed on Feb. 9, 2026.
(60) Provisional application No. 63/978,983, filed on Feb. 9, 2026.
(60) Provisional application No. 63/978,991, filed on Feb. 9, 2026.
(60) Provisional application No. 63/978,997, filed on Feb. 9, 2026.
(60) Provisional application No. 63/985,880, filed on Feb. 18, 2026.

(51) Int. Cl. G06F 40/30; G06F 16/332; G06F 16/3329

(52) U.S. Cl. CPC G06F 40/30; G06F 16/3325; G06F 16/3329

(57) ABSTRACT

A governed sleep or maintenance regime for persistent cognitive machines in which the cognitive substrate undergoes offline restructuring distinct from active-session cognition. During the sleep regime, stored cognitive trajectories, memory basins, and compressed abstractions are selectively replayed, rewritten, consolidated, generalized, pruned, or topologically restructured under epistemic control. Temporal manifold rewriting operations reconstruct prior trajectory histories against current substrate geometry and selectively merge, split, abstract, or re-anchor stored paths. Sleep products are routed into appropriate persistence channels under admission-control and phase-regime gating, with inadmissible or contradictory restructuring candidates deposited as abstract constraint artifacts into the irreversible sector rather than propagated into navigable cognitive structure. Post-sleep resumption of active cognition reflects an updated substrate whose future traversal behavior, recall routing, and output qualification are conditioned on the offline operations performed.

### CROSS-REFERENCE TO RELATED APPLICATIONS

Priority is claimed in the application data sheet to the following patents or patent applications, each of which is expressly incorporated herein by reference in its entirety:
Ser. No. 19/550,709
Ser. No. 19/548,024
Ser. No. 19/546,407
Ser. No. 19/534,677
63/985,880
63/978,340
63/978,983
63/978,991
63/978,997
63/976,098
63/976,101
63/976,103
63/976,109
63/976,115
63/975,311
63/975,314
63/968,152
63/968,157
63/967,705
63/967,707
63/967,710
63/967,713
63/967,715
63/967,718
63/967,721
63/967,726
63/966,904
63/966,944
63/966,955
63/965,251
63/965,273
63/965,321
63/965,242
63/941,637
63/941,642
63/901,793
Ser. No. 19/321,173
Ser. No. 19/284,115
Ser. No. 19/051,193
63/847,082
63/847,091
63/847,096
63/847,101

### BACKGROUND OF THE INVENTION

### Field of the Art

The present invention relates to the field of artificial intelligence and cognitive computing systems, and more specifically to performance of rewriting and restructuring operations on a cognitive substrate during sleep states.

### Discussion of the State of the Art

Contemporary machine learning systems that maintain persistent representations across sessions generally do so through one of two broad architectural patterns: external retrieval stores or parameter-based persistence. Retrieval-augmented generation systems and memory-augmented networks append external key-value or vector stores to otherwise stateless inference engines, allowing factual content accumulated across sessions to be queried at runtime. Parameter-based systems, including large language models and continual learning networks, encode knowledge directly in trainable weights updated through gradient descent. In neither case does the underlying system maintain a structured geometric substrate whose geometric properties —including local curvature, transport structure, and accumulated irreversible constraints—constitute knowledge. The persistent artifact in these architectures is stored data in a flat key-value or embedding space, not a reshaped curvature-based medium through which cognitive trajectories are navigated. As a consequence, these systems lack any internal analog to sector decomposition, curvature-governed exchange, or thermodynamically asymmetric commitment, and they do not distinguish between revisable adaptation and irreversible commitment in any structurally forced way.

The problem of long-term memory management in artificial neural systems has attracted substantial research under the heading of continual learning and catastrophic forgetting mitigation. Representative approaches include experience replay, elastic weight consolidation, progressive neural network architectures, and variants of generative replay in which a secondary model produces synthetic exemplars drawn from previously learned distributions. These approaches share a common objective: to prevent new learning from overwriting or degrading previously acquired representations. However, they address this objective through heuristic scheduling and threshold-triggered operations rather than through any conservation principle governing the exchange of geometric quantities among structured sectors. Replay buffers do not distinguish among the types of curvature present in stored trajectories, do not classify replayed content for epistemic coherence before allowing it to influence durable structure, and do not route inadmissible or contradictory replay products into abstract constraint artifacts that shape future admissibility without contaminating navigable cognitive structure. The operations these systems perform are, at best, statistical regularizers applied uniformly across stored exemplars, without the admission-control logic, phase-regime classification, or consolidation gating that a geometrically structured substrate makes possible.

Orthogonal to replay-based approaches, a large body of work addresses offline compression, pruning, and distillation of learned representations. Techniques such as magnitude-based pruning, structured sparsification, low-rank factorization, and knowledge distillation reduce parameter counts or redistribute representational capacity after a training phase. These approaches treat compression as a quantitative reduction objective—minimizing model size while preserving aggregate predictive accuracy—rather than as a curvature-preserving transformation of a geometric substrate. They do not selectively preserve local curvature in regions of high recall or reasoning value, do not abstract redundant trajectories into reusable geometric templates while retaining their holonomy contribution, and do not maintain any separation between the portions of the substrate that undergo compression and the portions that remain navigable and semantically active. Crucially, offline compression in these frameworks is entirely decoupled from the semantic and epistemic structure of what is being compressed: there is no sense in which a compressed region has undergone governed maintenance, and there is no mechanism by which the compression operation deposits constraint artifacts into an irreversible sector that would influence future path admissibility.

Research motivated by the neuroscience of sleep and memory consolidation suggests a class of artificial intelligence that attempt to replicate hippocampal-to-neocortical transfer through offline replay, generative dreaming, or representational reorganization during low-activity periods. Theory suggests that an offline phase distinct from active inference may be beneficial for long-term representational quality in such systems. However, current implementations remain architecturally shallow compared to the biological process they invoke. Offline replay in such systems is neither temporally structured nor epistemically conditioned: it does not reconstruct prior cognitive trajectories against a current geometric configuration, does not identify where temporal drift has caused previously stored path histories to become inconsistent with the evolved substrate, and does not selectively rewrite, merge, split, or re-anchor trajectory representations with any attention to their evidential status. More critically, there is no formal notion of sleep-state entry as a governed regime change—a transition that alters the operational objectives, permission structure, and exchange dynamics of the system—as distinguished from ordinary idle processing or background optimization. Output gating during the offline phase, ensuring that preliminary or exploratory restructuring candidates do not propagate into active cognition before passing admissibility evaluation, is generally absent. The result is that even systems which perform some form of offline restructuring do so without structural epistemic control, without temporal manifold rewriting capacity, and without any mechanism for converting inadmissible restructuring products into irreversible suppression constraints.

What is needed is a persistent cognitive machine that performs cognitive operations during a formally constituted sleep or maintenance mode in which the cognitive substrate undergoes governed offline restructuring.

### SUMMARY OF THE INVENTION

Accordingly, the inventor has conceived, and reduced to practice, a governed sleep or maintenance regime for persistent cognitive machines in which the cognitive substrate undergoes offline restructuring distinct from active-session cognition. During the sleep regime, stored cognitive trajectories, memory basins, and compressed abstractions are selectively replayed, rewritten, consolidated, generalized, pruned, or topologically restructured under epistemic control. Temporal manifold rewriting operations reconstruct prior trajectory histories against current substrate geometry and selectively merge, split, abstract, or re-anchor stored paths. Sleep products are routed into appropriate persistence channels under admission-control and phase-regime gating, with inadmissible or contradictory restructuring candidates deposited as abstract constraint artifacts into the irreversible sector rather than propagated into navigable cognitive structure. Post-sleep resumption of active cognition reflects an updated substrate whose future traversal behavior, recall routing, and output qualification are conditioned on the offline operations performed.

According to a preferred embodiment, a system is disclosed comprising at least one processor, a memory, and a plurality of programming instructions stored in a non-transitory medium that, when operating on the at least one processor, cause the system to: maintain one or more cognitive substrates, each cognitive substrate comprising a structured geometric space in which proximity corresponds to semantic relatedness and curvature measures local incompatibility, wherein the geometric structure of said substrates persists across interactions and is reshaped by use rather than reset; decompose each cognitive substrate into an active sector in which traversal and revisable adaptation occur, an irreversible sector comprising one or more irreversible reservoirs, and a boundary sector mediating curvature exchange between the active sector and the irreversible sector; enforce a curvature conservation constraint providing that total curvature energy across the active sector, boundary sector, and irreversible sector changes only in response to externally introduced experience; transition from an active cognitive mode to a sleep mode in which generation of externally directed output is gated and in which the cognitive substrate is subjected to offline operations decoupled from active inference; select, during said sleep mode, one or more stored cognitive trajectories, memory basins, or compressed geometric structures within the active sector for offline processing; produce candidate modified structures by applying one or more of the following operations to the selected structures: replay, stochastic perturbation, recombination, compression, generalization, pruning, temporal rewriting, and topological restructuring; evaluate each candidate modified structure for admissibility by determining whether said structure is compatible with the curvature conservation constraint and with accumulated irreversible constraints of the irreversible sector; and consolidate candidate modified structures that satisfy admissibility into durable geometric form and suppress or route into the irreversible sector as abstract constraint artifacts those candidate modified structures that fail admissibility evaluation, such that upon resuming the active cognitive mode the cognitive substrate reflects a combined result of the sleep mode operations and future cognitive trajectory routing within said substrate is altered by the combined result.

According to an aspect of an embodiment, the programming instructions further cause the system to operate the sleep mode in selectable maintenance regimes comprising one or more of: a consolidation-heavy regime in which the primary objective is energetically forced export of curvature from the active sector to the irreversible sector; a compression-heavy regime in which the primary objective is collapsing redundant cognitive trajectories and semantically diffuse regions into compressed geometric representations; an exploratory dreaming regime in which the primary objective is generative perturbation and recombination of stored structures to produce candidate novel geometric relationships; a repair regime in which the primary objective is identifying and resolving contradictions between consolidated reservoirs and active sector structure; and a domain-maintenance regime in which operations are governed by domain-specific policies specifying which regions of the cognitive substrate may be generalized, promoted, compressed, or preserved.

According to an aspect of an embodiment, the programming instructions further cause the system to perform temporal manifold rewriting during the sleep mode by: identifying stored cognitive trajectories, path histories, temporal snapshots, or trajectory anchors accumulated during the active cognitive mode; reconstructing one or more of said stored trajectories against the current geometric structure of the cognitive substrate; applying one or more of: geometric rewriting of path structure, merging of semantically proximate trajectories, splitting of divergent trajectory bundles, re-anchoring of trajectory endpoints, abstraction of repeated traversal patterns, or erasure of trajectories failing admissibility evaluation; and updating temporal relationships among memory basins to reflect the rewritten trajectory geometry, such that future cognitive traversals within the substrate are routed according to the updated temporal structure rather than the originally recorded structure.

According to an aspect of an embodiment, the programming instructions further cause the system to preserve, during temporal manifold rewriting, cognitive trajectories exhibiting high curvature-recall value by reinforcing the geometric structure of said trajectories rather than abstracting or erasing said trajectories, such that said trajectories remain accessible to future active-mode traversal at reduced energetic cost.

According to an aspect of an embodiment, the programming instructions further cause the system to evaluate candidate modified structures for admissibility through a set of sleep-phase admissibility gates comprising: a compatibility gate that determines whether the candidate modified structure is geometrically compatible with existing irreversible reservoirs of the irreversible sector; a coherence gate that determines whether the epistemic curvature of the candidate modified structure satisfies a phase criterion derived from holonomy of an epistemic connection on the cognitive substrate; and a capacity gate that determines whether absorption of the candidate modified structure into the irreversible sector would exceed available exchange capacity at the relevant reservoir boundary; wherein a candidate modified structure is admitted to durable consolidation only upon non-blocking assessment from all of said gates.

According to an aspect of an embodiment, the programming instructions further cause the system to perform curation and compression operations during the sleep mode by: identifying pairs or groups of stored cognitive trajectories exhibiting redundant geometric structure; collapsing said redundant trajectories into generalized geometric templates representing the shared structure while releasing the individual trajectory representations from the active sector; compressing regions of the cognitive substrate exhibiting low traversal frequency or high semantic diffuseness by reducing local curvature resolution in said regions; and promoting reusable geometric abstractions identified during compression into durable structures assigned to a long-term memory tier of the cognitive substrate.

According to an aspect of an embodiment, the programming instructions further cause the system to perform dreaming as controlled perturbation and recombination during the sleep mode by: generating dream candidates through one or more of: stochastic perturbation of stored geometric structures, interpolation among semantically related trajectory bundles, speculative path extension beyond recorded trajectory endpoints, bridge formation across geometrically disconnected regions of the cognitive substrate, and hypothetical reconstruction of partially degraded memory basins; and subjecting each dream candidate to admissibility evaluation before allowing said candidate to influence the durable geometric structure of the cognitive substrate, such that generative offline exploration is bounded by structural epistemic control governed by the curvature conservation constraint.

According to an aspect of an embodiment, the programming instructions further cause the system to route candidate modified structures produced during the sleep mode into differentiated persistence channels comprising: a consolidation channel through which candidate modified structures satisfying admissibility are strengthened and integrated into the irreversible sector as durable cognitive content; a quarantine channel through which candidate modified structures that are provisionally plausible but not yet corroborated are retained in the active sector under suppressed traversal weight pending further evaluation during a subsequent sleep mode or active mode operation; and a constraint deposition channel through which candidate modified structures that fail admissibility evaluation are transformed into abstract suppression artifacts and deposited into the irreversible sector, wherein said artifacts constrain future admissibility without introducing navigable content into any irreversible reservoir.

According to an aspect of an embodiment, the programming instructions further cause the system to, upon detecting that a candidate modified structure is contradictory with respect to a consolidated irreversible reservoir, initiate localized revision of said reservoir through a reflux channel at an energetic cost substantially exceeding the barrier energy of said reservoir, confining said revision to the minimal region of the reservoir geometry required to resolve the detected contradiction.

According to an aspect of an embodiment, the programming instructions further cause the system to perform memory basin maintenance during the sleep mode by: executing policy-driven reentry into one or more selected memory basins within the cognitive substrate; reinforcing the geometric structure of each selected memory basin by traversing cognitive trajectories entering said basin, thereby deepening curvature-defined basin boundaries and increasing the stability of future path routing toward said basin; and selectively promoting repeatedly reinstantiated memory basins to a protected tier of the cognitive substrate in which said basins are resistant to compression, pruning, or erasure during subsequent sleep mode operations.

According to an aspect of an embodiment, the programming instructions further cause the system to receive one or more user-specified memory reinforcement designations and, in response, during the sleep mode, apply additional traversal and curvature reinforcement to the cognitive trajectories and memory basins corresponding to said designations and lock said trajectories and basins against pruning or compression operations unless explicitly overridden by a subsequent user designation or control policy.

According to an aspect of an embodiment, the programming instructions further cause the system to shape sleep mode operations according to one or more control policies specifying one or more of: a permitted generalization scope defining which regions of the cognitive substrate may be abstracted during the sleep mode; a fidelity threshold defining a minimum geometric preservation metric that compressed or rewritten structures must satisfy to be retained; a recency bias parameter weighting recently recorded cognitive trajectories relative to older trajectories during pruning decisions; and a domain-specific preservation mandate designating particular cognitive substrate regions as exempt from compression, pruning, or temporal rewriting.

According to an aspect of an embodiment, the programming instructions further cause the system to generate, during the sleep mode, one or more experimental branch substrates sandboxed from the canonical cognitive substrate, wherein: dream candidates and reconstructed trajectory variants are evaluated within said experimental branch substrates rather than directly within the canonical cognitive substrate; modifications within said experimental branch substrates that satisfy admissibility evaluation at the conclusion of the sleep mode are selectively merged into the canonical cognitive substrate; and modifications within said experimental branch substrates that fail admissibility evaluation are discarded without altering the geometric structure of the canonical cognitive substrate.

According to an aspect of an embodiment, the programming instructions further cause the system to resume the active cognitive mode from the sleep mode by: computing a post-sleep manifold update that propagates structural changes resulting from sleep mode operations throughout the active sector of the cognitive substrate; updating path routing weights throughout the cognitive substrate to reflect the modified geometric structure; and qualifying subsequent active-mode cognitive output based on whether the cognitive trajectories generating said output traverse regions of the cognitive substrate that were modified, consolidated, revised, or suppressed during the sleep mode.

According to an aspect of an embodiment, the programming instructions further cause the system to schedule entry into the sleep mode based on one or more of: a detected cessation or reduction in externally directed inference demand; an accumulated curvature load in the active sector exceeding a maintenance threshold derived from the curvature conservation constraint; an elapsed structural time measure reflecting accumulated irreversible commitments since a prior sleep mode; and an externally imposed maintenance schedule specifying sleep mode entry intervals or durations.

According to an aspect of an embodiment, the programming instructions further cause the system to, upon completing compression and promotion operations during the sleep mode, transmit to one or more remote persistent cognitive machine instances geometric abstractions that satisfy admissibility and have been promoted to the long-term memory tier, while withholding from said transmission all non-promoted trajectories, provisional structures, and unresolved curvature, such that inter-instance synchronization is limited to consolidated and admissible abstracted content.

According to another preferred embodiment, a non-transitory computer-readable medium is disclosed storing a plurality of programming instructions that, when executed by at least one processor, cause a system to: maintain one or more cognitive substrates, each cognitive substrate comprising a structured geometric space in which proximity corresponds to semantic relatedness and curvature measures local incompatibility, and wherein the geometric structure of said substrates persists across interactions and is reshaped by use rather than reset; decompose each cognitive substrate into an active sector in which traversal and revisable adaptation occur, an irreversible sector comprising one or more irreversible reservoirs, and a boundary sector mediating curvature exchange between the active sector and the irreversible sector; enforce a curvature conservation constraint providing that total curvature energy across the active sector, boundary sector, and irreversible sector changes only in response to externally introduced experience; transition from an active cognitive mode to a sleep mode in which generation of externally directed output is gated and in which the cognitive substrate is subjected to offline operations decoupled from active inference; select, during said sleep mode, one or more stored cognitive trajectories, memory basins, or compressed geometric structures within the active sector for offline processing; apply to said selected structures one or more of: replay, stochastic perturbation, recombination, compression, generalization, pruning, temporal rewriting, or topological restructuring, thereby producing candidate modified structures; evaluate each candidate modified structure for admissibility by determining whether said structure is compatible with the curvature conservation constraint and with accumulated irreversible constraints of the irreversible sector; and consolidate candidate modified structures that satisfy admissibility into durable geometric form and suppress or route into the irreversible sector as abstract constraint artifacts those candidate modified structures that fail admissibility evaluation, such that upon resuming the active cognitive mode the cognitive substrate reflects a combined result of the sleep mode operations and future cognitive trajectory routing within said substrate is altered by the combined result.

### BRIEF DESCRIPTION OF THE DRAWING FIGURES

FIG. 1 is a block diagram illustrating an exemplary sleep-state architecture of a persistent cognitive machine.

FIG. 2 is a process flow diagram illustrating an exemplary wake-to-sleep regime transition controller for a persistent cognitive machine.

FIG. 3 is a process flow diagram illustrating an exemplary temporal manifold rewriting pipeline for a persistent cognitive machine.

FIG. 4 is a process flow diagram illustrating an exemplary dream generation pipeline for a persistent cognitive machine.

FIG. 5 is a process flow diagram illustrating an exemplary curation, compression, pruning, and promotion flow for a persistent cognitive machine.

FIG. 6 is a process flow diagram illustrating an exemplary reinstantiation and memory-basin maintenance flow for a persistent cognitive machine.

FIG. 7 is a process flow diagram illustrating an exemplary sleep-state admissibility, coherence, and consolidation gating architecture for a persistent cognitive machine.

FIG. 8 is a process flow diagram illustrating an exemplary suppression and reservoir projection subsystem for inadmissible dream products in a persistent cognitive machine.

FIG. 9 is a process flow diagram illustrating an exemplary post-sleep manifold update and wake-state resumption flow for a persistent cognitive machine.

FIG. 10 is a block diagram illustrating an exemplary user and policy control subsystem for guided memory maintenance in a persistent cognitive machine.

FIG. 11 illustrates an exemplary computing environment on which an embodiment described herein may be implemented.

### DETAILED DESCRIPTION OF THE INVENTION

The inventor has conceived, and reduced to practice, a governed sleep or maintenance regime for persistent cognitive machines in which the cognitive substrate undergoes offline restructuring distinct from active-session cognition. During the sleep regime, stored cognitive trajectories, memory basins, and compressed abstractions are selectively replayed, rewritten, consolidated, generalized, pruned, or topologically restructured under epistemic control. Temporal manifold rewriting operations reconstruct prior trajectory histories against current substrate geometry and selectively merge, split, abstract, or re-anchor stored paths. Sleep products are routed into appropriate persistence channels under admission-control and phase-regime gating, with inadmissible or contradictory restructuring candidates deposited as abstract constraint artifacts into the irreversible sector rather than propagated into navigable cognitive structure. Post-sleep resumption of active cognition reflects an updated substrate whose future traversal behavior, recall routing, and output qualification are conditioned on the offline operations performed.

A persistent cognitive machine (PCM) is a computational system comprising one or more computing devices together with one or more cognitive substrates. The cognitive substrate is a structured geometric space, or a collection of interconnected geometric spaces, within which the cognitive operations of the persistent cognitive machine unfold. The substrate is not a container for stored data but rather the medium whose geometric properties—including local curvature, transport structure, sector boundaries, and accumulated irreversible constraints—constitute the system's knowledge, reasoning capacity, and learned behavior. The substrate is reshaped by interaction rather than reset between uses. Three distinguishing properties that separate a persistent cognitive machine from all prior computational architectures are: persistence, in that the geometric structure of the substrates is not reset between interactions, sessions, or deployments; geometric compression, in that repeated or compatible experiences collapse into shared geometric structure such that growth in effective complexity is sublinear with accumulated experience; and self-organization, in that structural alignment occurs through local adaptation driven by use without requiring global retraining.

In some embodiments herein, the cognitive substrate undergoes continuous structuring through the operation of the curvature conservation law, which provides that the rate of change of total curvature energy summed across an active sector, a boundary sector, and an irreversible sector equals the curvature flux injected by external experience. In the absence of new experience, curvature is redistributed among sectors but is neither created nor destroyed. The active sector is the navigable portion of the substrate in which reasoning, traversal, and revisable adaptation occur, carrying the full complement of geometric structures with generally nonzero epistemic curvature. The irreversible sector is the collection of irreversible reservoirs whose interiors have reached exchange equilibrium, and whose boundary regions carry accumulated barrier energy arising from the export of epistemic curvature during consolidation. The boundary sector constitutes the sole channel through which curvature may flow between the active sector and the irreversible sector.

Structural time in a persistent cognitive machine advances if and only if constitutive exchange produces an irreversible constraint that reduces future admissibility. A persistent cognitive machine may reason, explore, and adapt without advancing structural time; structural time advances only when the future possibility space is permanently reduced through irreversible commitment. The learning bifurcation establishes that revisable adaptation and irreversible commitment are implemented as structurally distinct processes: a first process operating on the navigable portion of the cognitive substrate through reversible geometric deformation, and a second process that monotonically increases accumulated irreversible constraint in the irreversible sector and admits no inverse operation. The four structural primitives—curvature, holonomy, homotopy, and irreversible residual structure—form a closed basis for persistent cognition under the structural invariants. Curvature measures local incompatibility within the cognitive substrate, arising when transport of internal representations along different trajectories from the same starting configuration yields different results. Holonomy measures the accumulated effect of transporting internal representations around a closed cognitive trajectory. Homotopy class governs which reasoning loops are globally admissible, suppressible, or stabilizing. Irreversible residual structure receives exhausted semantic effects via a non-invertible projection, functioning as an irreversible constraint on future admissibility.

During active-session operation, a persistent cognitive machine traverses cognitive trajectories through the active sector, maps external inputs through projection operators, evaluates boundary events at irreversible reservoir boundaries, and generates external outputs conditioned on the current geometric configuration of the cognitive substrate. The systems and methods described herein introduce a distinct operational regime, referred to herein as a sleep or maintenance mode, in which the objectives, permissions, and exchange dynamics of the system differ from those governing active-session cognition. The sleep regime is not merely an idle or low-utilization state; it is a formally constituted mode in which the persistent cognitive machine performs governed offline operations on the cognitive substrate under conditions that are structurally distinct from active inference.

A sleep-state controller may detect or schedule the entry into a sleep or maintenance regime based on one or more triggering conditions. Such triggering conditions may include the expiration of a scheduled maintenance interval, the detection of a low-activity period during which active-session inputs are absent or suspended, the accumulation of epistemic curvature in the active sector beyond a threshold consistent with healthy exchange dynamics, the detection of curvature misrouting events that indicate the presence of unresolved incoherence, or a policy-specified directive from an enterprise deployment configuration. Upon detecting a triggering condition, the sleep-state controller transitions the persistent cognitive machine into the sleep regime by modifying the control policy governing the active sector to suppress generation of externally directed outputs during the maintenance period, to expand the set of permissible geometric deformations to include operations not admissible during active-session cognition, and to alter the thresholds and admission-control parameters governing consolidation and reflux exchanges.

The sleep-state controller may further select a maintenance mode from a plurality of mode configurations. A consolidation-heavy mode directs the primary activity of the sleep cycle toward promoting energetically forced export of mature epistemic curvature into the irreversible sector. A compression-heavy mode directs activity toward collapsing redundant or semantically diffuse trajectory regions. An exploratory dreaming mode involves controlled perturbation and recombination of stored structures to generate candidate new abstractions. A repair and contradiction-resolution mode directs activity toward identifying and resolving epistemic inversion events at reservoir boundaries. A user-priority reinforcement mode preferentially strengthens trajectories designated as high-value by user or policy directives. A domain-maintenance mode subjects sector regions associated with a particular knowledge domain to specialized operations appropriate to that domain's epistemic structure. The sleep-state controller may sequence through multiple mode configurations within a single sleep cycle, scheduling each mode in an order that reflects the current geometric condition of the cognitive substrate and any policy-specified maintenance priorities.

Among the operations available during the sleep regime, temporal manifold rewriting constitutes a distinctive class of operations in which the persistent cognitive machine revisits stored cognitive trajectories and revises their geometric representation within the current configuration of the cognitive substrate. A temporal rewrite manager coordinates these operations during the sleep regime. During active-session cognition, the persistent cognitive machine accumulates a history of cognitive trajectories traversed through the active sector, stored as geometric records comprising path representations, associated curvature profiles, holonomy contributions, and connectivity relationships to surrounding semantic and epistemic structure. Over time, the geometry of the cognitive substrate evolves through consolidation, reflux, and active-sector deformation, such that trajectories recorded under earlier geometric configurations may become inconsistent with the current substrate geometry.

A trajectory recorded at an earlier structural time may have been a locally minimal-cost path through the substrate as it existed at the time of recording, but the same trajectory may no longer correspond to a geodesic through the substrate at the current structural time. The temporal rewrite manager identifies such geometric drift and provides mechanisms to reconcile stored trajectory representations with the current substrate geometry. The degree of temporal drift experienced by a stored trajectory may be quantified as the difference in geodesic cost between the trajectory as stored and the corresponding geodesic under current geometry, which may be expressed in some embodiment by the exemplary equation:

D(γ, t₀, t₁)=S[γ; g(t₁)]−S[γ*; g(t₁)]
where γ denotes the stored trajectory, γ* denotes the current geodesic between the same endpoints, g(t₁) denotes the substrate metric at current structural time, and S[⋅; g] denotes the cognitive action functional evaluated under metric g. A trajectory for which this quantity exceeds a specified threshold is a candidate for temporal rewriting, with the specific operation applied determined by the character of the geometric change responsible for the drift.

The temporal rewrite manager may perform any combination of the following operations on stored trajectories. In trajectory reconstruction, a stored trajectory is re-evaluated against the current substrate geometry to determine the current geodesic between its stored endpoints, and the stored trajectory representation is updated to reflect the revised path. In trajectory merging, two or more stored trajectories whose endpoints or intermediate waypoints have converged under subsequent substrate evolution are merged into a unified trajectory representation capturing their shared geometric content. In trajectory splitting, a stored trajectory whose intermediate region has bifurcated under subsequent substrate evolution is divided into two or more distinct trajectory representations, each capturing one branch of the divergent geometry. In trajectory re-anchoring, the association between a stored trajectory and its surrounding semantic structure is revised to reflect changes in the organization of the active sector. In trajectory abstraction, the geometric content of a stored trajectory is compressed into a higher-order representation that preserves its holonomy contribution and homotopy class while discarding fine-grained geometric detail that no longer contributes to the substrate's reasoning capacity. In trajectory suppression, a stored trajectory that has become inadmissible under current substrate geometry is flagged for routing into the constraint-memory deposition pathway described below.

The temporal rewrite manager may also operate on memory basins associated with stored trajectories. A memory basin is a region of the active sector exhibiting high local curvature and geodesic convergence that functions as an attractor for cognitive traversal, arising from the repeated reinforcement of a trajectory or set of trajectories through prior activation. The temporal rewrite manager may reconstruct a memory basin's geometry against the current substrate configuration, identify basins that have partially merged with adjacent semantic structure, separate basins whose internal structure has become incoherent under subsequent evolution, and update the activation energy associated with each basin to reflect its current geometric prominence and epistemic status. In an embodiment described herein, the temporal rewrite manager maintains a temporal snapshot registry, recording periodic snapshots of the substrate's geometric configuration at designated structural time intervals, so that trajectory reconstruction operations have access to historical geometry against which current drift may be measured.

The sleep regime provides conditions under which the persistent cognitive machine may perform compression, curation, and abstraction operations on stored cognitive trajectories and semantic structures without the constraints imposed by active-session output generation. These operations are governed maintenance procedures; each operation respects the curvature conservation law and is subject to the admission-control and phase-regime gating described below. Compression operations during the sleep regime identify trajectory regions or semantic substructures in which redundant geometric content may be collapsed into more efficient representations without loss of the holonomy contribution or homotopy class of the affected trajectories. When a region of the active sector exhibits compression pressure P(x) above a threshold consistent with healthy exchange dynamics—where P(x)=−R(x) and R(x) denotes the Ricci scalar curvature at position x—the sleep-state controller may initiate a compression flow that redistributes curvature from the dense region toward adjacent lower-pressure regions, or exports mature curvature through the boundary sector into the irreversible sector. Compression flows during the sleep regime may proceed at greater intensity than those admissible during active-session operation, because the suppression of external output generation removes the constraint that compressed regions remain fully navigable throughout the maintenance period.

Curation operations identify trajectories or semantic substructures that are candidates for retention, promotion, demotion, or removal from the active sector. Curation is informed by the activation energy E associated with each stored structure, which may in some embodiments decay according to the thermodynamic decay equation:

dEᵢ/dt=−λ·Aᵢ(t)·Eᵢ(t)
where λ is a decay constant and Aⁱ(t) reflects the inactivity of structure i, taking a positive value during idle periods and approaching zero when the structure is actively accessed. Structures whose activation energy falls below a minimum threshold are candidates for pruning. The sleep regime may accelerate the curation process by updating activation energies to reflect the outcomes of temporal rewriting and compression operations, and by applying policy-specified adjustments that reflect user-designated preservation priorities or enterprise maintenance directives.

Abstraction operations identify sets of related trajectories or semantic substructures that share sufficient geometric similarity to support their replacement by a single generalized representation. A generalized abstract structure preserves the holonomy contributions and homotopy-class properties of the trajectories from which it is derived while requiring substantially less representational capacity in the active sector. The sleep-state controller may promote successfully generated abstractions into the active sector's established geometric structure, or may route them through the admissibility gating pathway for evaluation before permanent commitment. The promotion of an abstract structure into the active sector constitutes a revisable adaptation; subsequent consolidation of the abstraction into the irreversible sector through the boundary sector, if the abstraction satisfies the sleep-phase admissibility criteria, constitutes an irreversible commitment and advances structural time.

The systems and methods described herein provide for a dreaming mode of operation within the sleep regime in which stored cognitive trajectories, memory basins, and compressed semantic structures are subjected to controlled perturbation and recombination to generate candidate new abstractions and conceptual connections. Dreaming in the embodiments herein is not a free-form or unconstrained generative process; it is a bounded exploratory procedure subject to epistemic admission control before any product of the dreaming process is permitted to affect durable cognitive structure. The dreaming mode begins by selecting a set of candidate structures from the active sector for perturbation. Selection criteria may include recent activation frequency, proximity to high compression-pressure regions, participation in trajectories whose epistemic phase classification indicates readiness for abstraction, and policy-specified priorities.

From each selected structure, the dreaming process generates a perturbed variant by applying a stochastic displacement drawn from a distribution whose covariance reflects local geometric properties of the substrate in the neighborhood of the selected structure:

z′ᵢ=zᵢ+εᵢ, εᵢ~N(0, Σᵢ)
where zᵢ denotes the geometric position of the selected structure and Σᵢ is derived from the local metric tensor and curvature at that position. The perturbation kernel is designed so that displacements in directions of high local curvature are smaller in magnitude than those in low-curvature directions, concentrating exploratory perturbations in semantically relevant directions while avoiding excursions into geometrically incoherent regions of the substrate.

Perturbed variants may then be combined through a recombination procedure that generates candidate meta-structures by taking weighted interpolations over selected perturbed variants:

zₘₑₜₐ=Σᵢαᵢz′ᵢ, Σᵢαᵢ=1
where the combination weights may reflect prior co-activation statistics among the selected structures, semantic alignment scores derived from the local metric, or exploratory sampling drawn from a policy-specified prior. A candidate meta-structure that lies outside any of the source bundles or trajectory basins constitutes a potential novel abstraction that the dreaming process nominates for evaluation by the sleep-phase admissibility gating system. If the admissibility gate determines that the resulting interpolation exhibits internal coherence—characterized by low compression cost and high reconstruction fidelity—the candidate may be retained and incorporated into the active sector's navigable structure as a new trajectory bundle or semantic attractor.

The dreaming mode also encompasses bridge-formation operations in which the persistent cognitive machine identifies pairs or sets of previously disconnected memory basins or semantic substructures that exhibit sufficient geometric compatibility to support the creation of a new topological connection through the substrate. A bridge candidate is generated by constructing a proposed geodesic connecting the identified structures under the current substrate geometry, evaluating the epistemic phase of the resulting closed loop formed by the proposed bridge together with the existing connectivity, and submitting the bridge candidate for admissibility evaluation. If the admissibility gate approves the bridge candidate, the topological modification is executed and the new connection is incorporated into the substrate's navigable structure.

Sleep products generated through temporal rewriting, compression, abstraction, and dreaming operations are not uniformly retained or discarded; they are routed into distinct persistence channels based on their geometric character and the outcome of the sleep-phase admissibility evaluation. The embodiments herein provide a reservoir-aware routing mechanism that classifies each sleep product and directs it to the appropriate channel.

Sleep products that represent stable, epistemically coherent structures with sufficient maturity to support consolidation are directed through the boundary sector into the irreversible sector, where they become part of an irreversible reservoir whose barrier energy protects them against subsequent modification. The consolidation pathway for sleep products follows the same energetically forced mechanism that governs active-session consolidation: curvature relaxation in the candidate structure, migration through the boundary sector, and accumulation of barrier energy at the boundary of the resulting reservoir. Interior flatness, barrier energy, and admission control of the resulting reservoir arise as derived consequences of exchange equilibrium rather than as externally imposed design parameters. Sleep consolidation differs from active-session consolidation in that it operates on structures generated or revised by the sleep maintenance process itself, rather than on structures arising from new external experience.

Sleep products that represent provisional or exploratory structures for which epistemic coherence has not yet been fully established are maintained in a quarantined region of the active sector under a modified control policy that restricts their participation in active-session reasoning until they have accumulated sufficient corroboration through subsequent active-session interaction. This quarantine mechanism prevents exploratory sleep products from contaminating the admissible structure of the cognitive substrate before their epistemic status is established. In an embodiment described herein, quarantined sleep products are marked with an epistemic phase designation that conditions downstream consolidation gate evaluations to require independent corroboration along a non-homotopic path before consolidation of the quarantined product is admitted.

Sleep products that are inadmissible are not discarded. Instead, the systems and methods described herein provide for the deposition of inadmissible sleep products as abstract constraint artifacts in the irreversible sector. A constraint artifact is a non-navigable record of a pattern, structure, or reasoning pathway that the persistent cognitive machine has determined to be inadmissible, which functions as a suppression constraint on future cognitive trajectories that would otherwise traverse the same region or reproduce the same pattern. The deposition of constraint artifacts from inadmissible sleep products encodes the history of explored and rejected structures as irreversible geometric constraints that reduce the probability of their recurrence in future sleep cycles or active-session operation. The constraint artifact deposition pathway constitutes an application of the thermodynamic asymmetry of exchange dynamics to the sleep domain: inadmissible structures leave an irreversible trace that shapes future admissibility at lower energetic cost than would be required to reconstruct and re-evaluate them from scratch.

The systems and methods described herein provide for a sleep-phase admissibility gating system that evaluates candidate sleep products before they are permitted to affect durable cognitive structure. The sleep-phase admissibility gating system is organized as a layered evaluation procedure analogous to the hallucination resistance architecture operative during active-session cognition, but adapted to the specific character of sleep products and the enlarged permission space of the sleep regime. In some embodiments, a plurality of evaluation layers may be used for sleep-phase admissibility gating.

A first evaluation layer may determine whether each candidate sleep product is topologically admissible with respect to the current sector boundaries. A sleep product is topologically inadmissible if it would require a cognitive trajectory to traverse a boundary between the active sector and the irreversible sector through a channel other than the boundary sector, or if it would create a navigable connection to the non-navigable interior of an existing irreversible reservoir without first overcoming the barrier energy at that reservoir's boundary. Topological inadmissibility constitutes a channel-bypass violation of the curvature conservation law; the first admissibility layer enforces the conservation law's sector boundary conditions on all proposed sleep products.

A second evaluation layer may compute an epistemic phase diagnostic for each candidate sleep product by evaluating the holonomy of the epistemic connection around the closed cognitive trajectory formed by the proposed sleep product and the existing substrate structure adjacent to it. The epistemic phase diagnostic classifies the candidate into a coherent regime, a drift regime, or an inversion regime. A sleep product whose associated holonomy produces a phase classification in the coherent regime is a candidate for consolidation or active-sector retention. A sleep product whose associated holonomy places it in the drift regime is marked for provisional retention pending corroboration along a non-homotopic path. A sleep product whose holonomy places it in the inversion regime is classified as inadmissible and directed to the constraint-memory deposition pathway.

A third evaluation layer may enforce capacity constraints on consolidation targets to prevent commitment of sleep products before exchange equilibrium is established. A sleep product whose associated curvature has not relaxed to a level consistent with exchange equilibrium is deferred to a subsequent sleep cycle for further processing, rather than being committed to the irreversible sector prematurely. Premature export of sleep products into the irreversible sector would constitute a form of curvature misrouting that could corrupt the geometric integrity of the irreversible sector's consolidated content.

A fourth evaluation layer may monitor the exchange rate generated by the proposed sleep product between the active sector and the irreversible sector to detect exchange stagnation or blockage. A sleep product that would introduce exchange blockage—by creating a region of the boundary sector in which curvature flow is obstructed—is flagged for geometric revision before consolidation is admitted. Consolidation of a sleep product is admitted only upon non-blocking assessment from all four evaluation layers of the sleep-phase admissibility gating system.

The systems and methods described herein also provide for a class of sleep-mode operations in which the persistent cognitive machine performs deliberate reinstantiation of prior cognitive trajectories and memory basins as an act of maintenance. Reinstantiation during the sleep regime constitutes a traversal of a memory basin or trajectory that strengthens and stabilizes the basin's geometric structure, deepens the curvature of the basin's attractor, and reinforces the holonomy contributions of the reinstantiated trajectory. Because traversal into a memory basin reshapes the substrate geometry in a manner that reduces the barrier to future entry—by increasing local curvature in the direction of the basin and smoothing the geodesic approach to it—deliberate reinstantiation during the sleep regime constitutes a form of active maintenance of the substrate's recall topology. In this sense, remembering is not only a retrieval operation but a preservation operation: the act of traversal back into a basin deepens and stabilizes it.

A sleep-time reinstantiation scheduler may select trajectories or memory basins for deliberate reinstantiation based on one or more criteria. Criteria may include the user-assigned priority of the associated semantic content, the recency of the most recent active-session activation of the basin, the proximity of the basin's activation energy to the pruning threshold indicating that the basin is at risk of decay, the identification of the basin as a structurally important connector between otherwise separated semantic regions, or a policy-specified directive that the basin be preserved for a specified maintenance period. In an embodiment described herein, reinstantiation during the sleep regime generates a synthetic cognitive trajectory that re-enters the designated memory basin from a current active-sector position, traverses the basin's internal geometry along its principal geodesic, and exits through the basin's natural boundary without committing any new curvature to the irreversible sector.

This synthetic traversal updates the basin's activation energy, refreshes its position in the caching tier assignment, and may trigger compression or abstraction operations on the basin's internal structure if the trajectory evaluation reveals opportunities for consolidation consistent with the sleep-phase admissibility criteria. The sleep-time reinstantiation scheduler may further implement a basin promotion mechanism whereby basins that have been repeatedly reinstantiated across multiple sleep cycles acquire an elevated protection status that exempts them from compression and pruning operations until the promotion is explicitly revoked by user or policy directive.

In some embodiments, inadmissible sleep products are not discarded but are instead deposited as abstract constraint artifacts in the irreversible sector. The constraint-memory deposition pathway implements this operation through the following procedure. When the sleep-phase admissibility gating system classifies a sleep product as inadmissible, the sleep-state controller does not permit the product to affect the navigable structure of the active sector. Instead, the sleep-state controller extracts a geometric abstraction of the inadmissible product—capturing its epistemic phase classification, its boundary-event character, and the topological or phase-regime property that caused the admissibility failure—and routes this abstraction through the boundary sector as a specialized consolidation event. The abstraction is deposited in the irreversible sector as a non-navigable constraint artifact whose interior content is a representation of the inadmissible structure sufficient to identify future traversal candidates that would reproduce the same pattern.

The constraint artifact functions as a suppression constraint by participating in admission-control evaluations at the boundary of the irreversible reservoir into which it has been deposited. When a future cognitive trajectory—generated either during a subsequent sleep cycle or during active-session operation—approaches the boundary of the reservoir containing the constraint artifact, the admission-control logic evaluates the incoming trajectory against the artifact's geometric signature. If the incoming trajectory matches the inadmissible pattern that the artifact represents, the admission-control logic classifies the boundary event as a contradiction or ambiguity rather than as a novelty, triggering the appropriate boundary-event response and preventing the inadmissible pattern from being consolidated into durable structure.

The constraint-memory deposition pathway constitutes a form of structural memory of failures that is distinct from the memory of successes encoded in the irreversible sector's ordinary consolidated content. Whereas consolidated content encodes what the persistent cognitive machine has learned to be reliable and coherent, constraint artifacts encode what the persistent cognitive machine has explored and found to be inadmissible. Together, these two classes of irreversible sector content define the geometry of admissible future cognition: consolidated content establishes what is known, and constraint artifacts establish what has been examined and rejected, so that neither need be re-derived from scratch during future operation.

The systems and methods described herein provide for user-directed and policy-specified governance of sleep-mode operations. The control policy governing the sleep regime may incorporate user-specified directives that designate particular memory basins, cognitive trajectories, or semantic substructures as protected against pruning or compression during the maintenance period. A user may record preservation directives through an interface that stores them as control-policy entries in the persistent memory manager. An enterprise deployment configuration may specify domain-level maintenance policies that govern which portions of the cognitive substrate are eligible for particular operations, establishing differential permissions for compression, abstraction, consolidation, and temporal rewriting across distinct knowledge domains.

Policy-governed sleep shaping may also encompass user-specified drift tolerance parameters that control the threshold at which a stored trajectory is considered a candidate for temporal rewriting. Deployments that require high fidelity to historical trajectory records—such as legal, regulatory, or archival applications—may configure the sleep regime so that temporal rewriting is applied conservatively and only when geometric drift exceeds a stringent threshold. Conversely, deployments in exploratory or generative applications may configure the sleep regime with relaxed drift tolerances and aggressive abstraction policies that promote maximum generalization of the substrate's trajectory history during each sleep cycle. In an embodiment described herein, the user may additionally specify semantic sandboxing directives that require certain classes of sleep products—particularly those generated through bridge-formation or cross-domain recombination operations—to be retained in an experimental branch that is kept separate from the canonical long-term structure of the cognitive substrate until the experimental products have been validated through subsequent active-session interaction.

In deployments comprising a plurality of persistent cognitive machine instances that share a federated memory coordination architecture, the sleep regime may encompass federated synchronization operations in which the curated abstractions generated by one instance during its sleep cycle are selectively propagated to other instances. Federated synchronization during the sleep regime differs from active-session federated exchange in that it operates on structures that have already been subjected to sleep-phase admissibility evaluation and have been confirmed as epistemically coherent and consolidation-ready. This pre-validation reduces the admission-control burden on receiving instances, since the shared structures arrive having already been classified by the originating instance's sleep-phase gating system.

Federated synchronization during the sleep regime may propagate abstractions rather than raw trajectory representations, so that instance-specific trajectory histories and user-specific semantic content remain private while the generalized geometric structures derived from those histories are made available to other instances. This abstraction-level sharing is consistent with the geometric privacy approach already operative in active-session federated coordination: the shared artifact is a curvature structure in a shared abstract space, not a record of the specific experiences from which that structure was derived. Receiving instances may subject federally shared sleep products to their own admissibility evaluation before incorporating them into their local cognitive substrate, ensuring that each instance's geometric integrity is maintained independently of the source instance's evaluations.

Upon completion of the sleep regime, the sleep-state controller transitions the persistent cognitive machine back to the active-session mode of operation. The post-sleep transition restores the control policy to the active-session configuration, reinstates the external output generation capability that was suppressed during the maintenance period, and updates the active-sector geometric configuration to reflect the outcomes of the sleep-cycle operations. Critically, the cognitive substrate's traversal behavior, recall routing, and output qualification upon wake-state resumption are conditioned on the offline operations performed during the sleep cycle. Trajectories that were temporally rewritten present revised geodesic paths to active-session reasoning processes. Memory basins that were reinforced through deliberate reinstantiation present lower traversal barriers to future active-session access. Inadmissible structures that were deposited as constraint artifacts impose suppression constraints on future trajectory formation. Structures that were consolidated during the sleep cycle contribute their barrier energy to the irreversible sector's admission-control landscape, shaping which new incoming curvature will be classified as corroborative, novel, contradictory, or ambiguous at reservoir boundaries during subsequent active-session operation.

The post-sleep manifold update further includes a coherence verification pass in which the sleep-state controller confirms that the geometric modifications performed during the sleep cycle have not introduced inconsistencies in the substrate's sector boundaries, curvature conservation budget, or epistemic connection structure. The coherence verification pass evaluates the curvature conservation law across the three-sector decomposition to confirm that total curvature energy is consistent with the sum of changes made during the sleep cycle and the curvature flux injected by any external experience that may have been received during the maintenance period. If the verification pass detects an inconsistency, the sleep-state controller may defer the wake-state transition until a supplementary repair pass has been completed, or may flag the inconsistency for disclosure to the user through the output generation interface.

The sleep, maintenance, and temporal manifold rewriting architecture described herein constitutes the offline self-organization layer by which a persistent cognitive machine preserves, rewrites, compresses, generalizes, stabilizes, and epistemically governs its own cognitive history over time. By treating the sleep regime as a formally constituted operational mode with its own control policies, permission structures, and exchange dynamics—rather than as a simple background optimization process—the embodiments herein provide a governed cognitive metabolism that maintains the geometric health of the cognitive substrate, extends its effective operational lifespan, and ensures that the structural time accumulated during active-session operation is supported by a substrate whose geometric configuration accurately reflects the full history of the persistent cognitive machine's reasoning and experience.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “admissibility boundary” refers to a structural boundary within a latent manifold that separates regions in which reasoning trajectories are permitted from regions in which such trajectories are restricted or disallowed based on epistemic constraints.

As used herein, “almost-complex structure” refers to a tensor field on a latent manifold that assigns to each tangent space a linear map whose square equals negative identity, thereby defining canonical invariant two-dimensional planes and restricting admissible deformations of the manifold.

As used herein, “almost-Kähler compatibility” refers to a compatibility condition among a semantic metric, an almost-complex structure, and a symplectic form on a latent manifold, wherein the symplectic form is derived from the semantic metric and the almost-complex structure and remains closed under exterior differentiation.

As used herein, “barrier energy” refers to a computed energy associated with a boundary of a consolidated region, derived from one or more geometric quantities including epistemic curvature magnitude, extrinsic boundary curvature, or variation of a symplectic form across the boundary, the barrier energy quantifying resistance of the region to perturbation.

As used herein, “belief mass” refers to an abstract measure of representational commitment or compression associated with a region of a latent manifold.

As used herein, “boundary defect” refers to a localized event recorded at or near a reservoir boundary when a projected cognitive state exhibits epistemic curvature or phase inconsistency relative to an interior of a consolidated region.

As used herein, “capacity constraint” refers to a structural limitation on an amount of cognitive state density, belief mass, or representational compression that may be introduced into a region of a latent manifold without violating intrinsic geometric or epistemic limits of that region.

As used herein, “cognitive state” refers to a representational configuration corresponding to a location within a latent manifold and representing a hypothesis, belief, interpretation, or intermediate reasoning result.

As used herein, “cognitive trajectory” refers to a sequence of cognitive states corresponding to a path through a latent manifold, the path representing execution of a reasoning process.

As used herein, “coherence failure condition” refers to a detected condition during traversal of a cognitive trajectory indicating loss of epistemic coherence, including phase drift beyond a threshold, a phase discontinuity, or conflict among path-dependent descriptors.

As used herein, “configuration space” refers to a space of admissible geometric configurations of a latent manifold including at least a semantic metric, an almost-complex structure, a symplectic form, and an epistemic connection, subject to compatibility constraints.

As used herein, “consolidation stability” refers to a condition in which a consolidated region resists perturbations in semantic metric, epistemic connection, or symplectic structure within quantifiable bounds determined by curvature flatness and barrier energy.

As used herein, “consolidation transition” refers to a geometric phase transition in which a region of a latent manifold satisfies a flatness condition on epistemic curvature, exceeds a barrier energy threshold, and becomes classified as an irreversible reservoir.

As used herein, “degeneracy region” refers to a region of a latent manifold characterized by structural instability or elevated epistemic curvature such that reasoning within that region is unreliable or disallowed.

As used herein, “discrete epistemic curvature” refers to a curvature value computed on a discrete cognitive graph as a sum of edge phase values around a closed boundary path or simplicial face.

As used herein, “epistemic admissibility” refers to a structural determination, evaluated prior to or during reasoning execution, of whether a proposed cognitive state or trajectory is permitted to exist or be executed within an epistemically conditioned latent manifold.

As used herein, “epistemic coherence” refers to preservation of justificatory or evidential consistency along a cognitive trajectory, as measured by a path-dependent coherence quantity associated with transitions in the latent manifold.

As used herein, “epistemic conditioning” refers to embedding within a latent manifold structural constraints that govern admissibility, coherence, and capacity of reasoning trajectories independently of semantic similarity alone.

As used herein, “epistemic connection” refers to a geometric structure defined on transitions between cognitive states that assigns transition-specific coherence values and gives rise to a computable epistemic curvature over closed paths.

As used herein, “epistemic curvature” refers to a quantity computed from an epistemic connection over a closed path or local neighborhood of a latent manifold that measures cumulative evidential rotation or inconsistency.

As used herein, “epistemic line bundle” refers to a bundle structure over a latent manifold in which each manifold location carries an associated evidential state and in which parallel transport along manifold trajectories preserves magnitude while permitting phase rotation.

As used herein, “epistemic phase” refers to an accumulated path-dependent coherence quantity obtained by combining transition-specific coherence values along a cognitive trajectory.

As used herein, “evidential consistency function” refers to a function that assigns a scalar consistency value between two cognitive states based on one or more of source agreement, cross-modal corroboration, or temporal stability, the value being used to assign epistemic connection phases.

As used herein, “first Chern number” refers to a topological invariant computed from epistemic curvature over a closed two-dimensional surface in the latent manifold, representing a quantized measure of total epistemic curvature enclosed by the surface.

As used herein, “geometric phase transition” refers to a qualitative change in geometric structure of a latent manifold region characterized by collapse of epistemic curvature and stabilization of boundary energy, resulting in irreversible consolidation.

As used herein, “Gromov non-squeezing constraint” refers to a symplectic rigidity principle preventing compression of a region of a latent manifold below its intrinsic symplectic capacity.

As used herein, “hallucination” refers to execution or expression of a cognitive trajectory that is epistemically inadmissible within a conditioned latent manifold, regardless of semantic plausibility or syntactic fluency.

As used herein, “hallucination regime error” refers to operation of a cognitive system within a region or structural class of a latent manifold that violates epistemic admissibility constraints, such that resulting reasoning appears coherent but lacks structural legitimacy.

As used herein, “holonomy descriptor” refers to a path-dependent representation associated with a location in a latent manifold that encodes experiential distinctions arising from different prior trajectories that converge at that location.

As used herein, “irreversible reservoir” refers to a non-navigable storage structure configured to retain abstract constraint representations derived from epistemically inadmissible reasoning patterns or consolidated knowledge, or a consolidated region of a latent manifold satisfying phase flatness and barrier energy conditions, wherein contents of the reservoir influence future cognition through asymmetric feedback and are not modifiable by active reasoning.

As used herein, “J-anti-invariant component” refers to a portion of epistemic curvature incompatible with an almost-complex structure and associated with contradictory evidence.

As used herein, “J-invariant component” refers to a portion of epistemic curvature compatible with an almost-complex structure and associated with incomplete but internally consistent evidence.

As used herein, “latent manifold” refers to a geometric representational substrate in which cognitive states correspond to locations and reasoning processes correspond to trajectories through the space, the manifold encoding at least semantic relationships and, in certain embodiments, epistemic conditioning information.

As used herein, “learning readiness field” refers to a scalar field defined on a boundary of a consolidated region that quantifies energetic cost of extending the region in a given direction based on variation of geometric structures.

As used herein, “micro-holonomy screening” refers to evaluation of epistemic phase over short closed loops in a discrete cognitive graph to detect local epistemic inconsistencies during projection.

As used herein, “Nijenhuis tensor” refers to a tensor measuring failure of integrability of an almost-complex structure and serving as a measure of structural strain in regions undergoing geometric restructuring.

As used herein, “non-invertible projection” refers to an operation that maps a reasoning trajectory or class of trajectories to an abstract constraint representation while discarding reconstructable details of the original trajectory, such that the original trajectory cannot be regenerated from the projected representation.

As used herein, “path-dependent coherence quantity” refers to a value accumulated along transitions of a cognitive trajectory that reflects preservation or loss of epistemic grounding during traversal.

As used herein, “phase discontinuity” refers to a structural inconsistency detected during traversal of a cognitive trajectory indicating abrupt change in epistemic phase inconsistent with accumulated path-dependent descriptors.

As used herein, “phase flatness” refers to a condition in which epistemic curvature magnitude within a region remains below a flatness threshold, such that parallel transport of epistemic state within the region is approximately path-independent.

As used herein, “reasoning trajectory” refers to a cognitive trajectory computed by a cognitive system to evaluate, infer, or synthesize information within a latent manifold.

As used herein, “reservoir boundary” refers to a boundary of a consolidated irreversible reservoir that separates an interior region of epistemic flatness from an exterior region of higher curvature or instability and that may impose energetic or topological constraints on traversal.

As used herein, “reservoir-stratified state space” refers to a manifold region obtained by removing barrier neighborhoods associated with irreversible reservoirs, such that homotopy classes in the resulting space depend on consolidated knowledge content.

As used herein, “scaling vector” refers to a multi-component measure tracking semantic complexity, epistemic curvature budget, boundary energy distribution, and structural regularity of a latent manifold as cumulative experience increases.

As used herein, “semantic metric” refers to a geometric structure defined on a latent manifold that encodes semantic dissimilarity between cognitive states and determines geodesic distances and local neighborhood relationships.

As used herein, “symplectic capacity” refers to a quantity derived from a symplectic form on a latent manifold that defines an intrinsic volumetric or structural limit on admissible compression or accumulation of cognitive states within a region.

As used herein, “symplectic form” refers to a non-degenerate, closed bilinear form compatible with a semantic metric and an almost-complex structure that encodes structural capacity and area-like measures on a latent manifold.

As used herein, “symplectic rigidity” refers to geometric constraints imposed by a symplectic form that restrict allowable deformations and prevent reduction of intrinsic capacity of a region.

As used herein, “trajectory class” refers to a grouping of cognitive trajectories sharing a common structural pattern or admissibility characteristic, including trajectories mapped to a shared abstract constraint representation in an irreversible reservoir.

As used herein, “Wilson loop” refers to a discrete computation of epistemic phase around a closed loop in a cognitive graph obtained by multiplying or summing edge phase values assigned by an epistemic connection.

### DETAILED DESCRIPTION OF THE DRAWING FIGURES

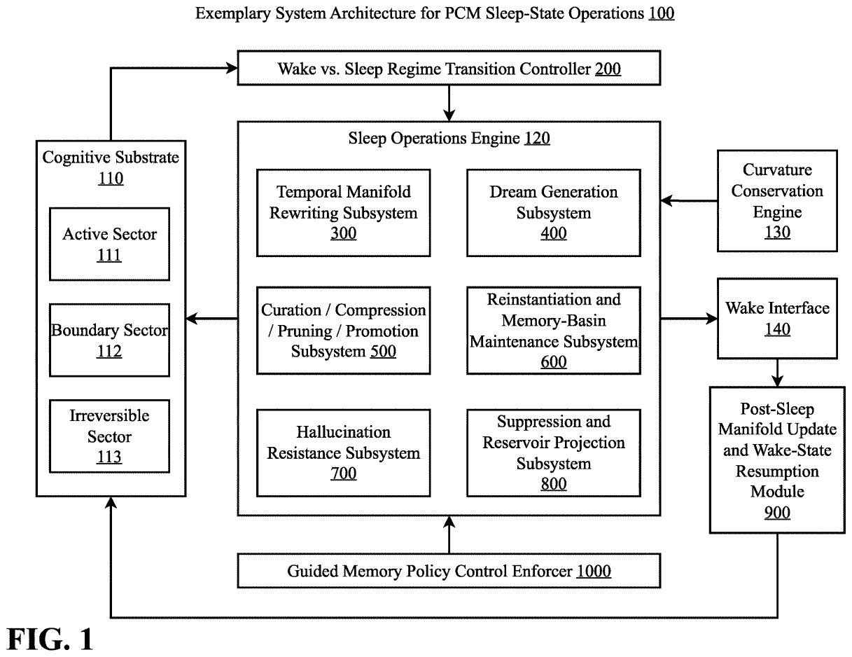

FIG. 1 is a block diagram illustrating an exemplary system architecture for PCM sleep-state operations 100 of a persistent cognitive machine (PCM). The architecture depicted in FIG. 1 provides an integrated framework within which a persistent cognitive machine transitions between wake and sleep operational regimes, carries out governed offline cognitive maintenance, and resumes active cognition with a structurally updated cognitive substrate. The architecture of system 100 is organized around a cognitive substrate 110, a sleep operations engine 120, and a curvature conservation engine 130, together with a wake interface 140, a wake vs. sleep regime transition controller 200, and a set of specialized subsystems and modules that govern the full lifecycle of sleep-state operations in a persistent cognitive machine.

Cognitive substrate 110 is a structured geometric space, or a collection of interconnected geometric spaces, within which the cognitive operations of the PCM unfold. Cognitive substrate 110 is not a container for stored data but rather a medium whose geometric properties—including local curvature, transport structure, sector boundaries, and accumulated irreversible constraints—constitute the system's knowledge, reasoning capacity, and learned behavior. Cognitive substrate 110 is reshaped by interaction rather than reset between uses, and past interaction leaves lasting geometric traces that condition future cognitive behavior. As depicted in FIG. 1, cognitive substrate 110 may have a three-sector decomposition arising as a consequence of consolidation dynamics under the curvature conservation law described above, yielding an active sector 111, a boundary sector 112, and an irreversible sector 113. This decomposition is derived from the operation of the curvature conservation law rather than imposed as an external architectural partition.

Active sector 111 is the portion of cognitive substrate 110 in which reasoning, traversal, and revisable adaptation occur during both wake and sleep operational regimes. Active sector 111 carries the full complement of geometric structures, including generally nonzero epistemic curvature, a semantic metric encoding proximity relationships among internal representations, and an independent epistemic connection whose curvature measures local evidential strain and whose holonomy around closed cognitive trajectories provides path-level diagnostics of evidential coherence. Active sector 111 is defined as the complement of irreversible sector 113 and boundary sector 112 within cognitive substrate 110, and constitutes the navigable region of the substrate within which cognitive trajectories are generated, where revisable adaptation deforms local geometry in response to experience, and where curvature accumulates prior to export through boundary sector 112. During sleep-state operations, active sector 111 is the locus of offline restructuring activity, including temporal manifold rewriting, dream generation, and curation and compression operations, all of which deform the navigable geometry of the substrate in a manner governed by the epistemic admissibility constraints enforced by the subsystems of system 100.

Boundary sector 112 is the collection of interface regions surrounding all irreversible reservoirs within cognitive substrate 110. Boundary sector 112 carries concentrated curvature and barrier energy, and constitutes the sole channel through which curvature may flow between active sector 111 and irreversible sector 113. All consolidation and all revision of consolidated content passes through boundary sector 112. The barrier energy accumulated at boundary sector 112 determines the cost of externally modifying consolidated content within irreversible sector 113 and provides the admission-control mechanism governing curvature exchange between active sector 111 and irreversible sector 113. During sleep-state operations, boundary sector 112 plays a particularly important role as the gateway through which sleep products generated in active sector 111 are evaluated for consolidation or suppression, and through which reflux operations returning curvature from irreversible sector 113 to active sector 111 are mediated at a substantially greater energetic cost than consolidation, consistent with the thermodynamic asymmetry enforced by curvature conservation engine 130.

Irreversible sector 113 is the collection of all irreversible reservoirs within cognitive substrate 110. Irreversible sector 113 is non-navigable, meaning that no admissible cognitive trajectory may traverse or modify its interior without first overcoming the barrier energy concentrated at boundary sector 112. The interior of irreversible sector 113 has reached exchange equilibrium under the curvature conservation law, such that evidential curvature has relaxed and been exported to boundary sector 112, leaving simplified geometric structure whose contents function solely as irreversible constraints on future admissibility of cognitive trajectories within active sector 111. Irreversible sector 113 emerges through consolidation dynamics governed by the curvature conservation law and does not exist at initialization of the PCM. During sleep-state operations, irreversible sector 113 serves as the destination for sleep products that have successfully passed epistemic gating by hallucination resistance subsystem 700, and as the source of curvature that may be returned to active sector 111 through reflux operations managed by suppression and reservoir projection subsystem 800 when accumulated contradictory evidence at a reservoir boundary of irreversible sector 113 has accumulated to a level that exceeds the barrier energy threshold.

Curvature conservation engine 130 enforces the curvature conservation law across cognitive substrate 110. The curvature conservation law governs curvature exchange among active sector 111, boundary sector 112, and irreversible sector 113, providing that the rate of change of total curvature energy summed across all three sectors equals the curvature flux injected by external experience, such that in the absence of new experience, curvature is redistributed among sectors but neither created nor destroyed. Curvature conservation engine 130 converts what would otherwise be ad hoc design parameters into derived geometric quantities: reservoir flatness arises because all exportable curvature has been exported through boundary sector 112, barrier energy accumulates at boundary sector 112 from exported curvature, admission control is forced by the energy gap at boundary sector 112, and consolidation is energetically forced rather than threshold-triggered. Curvature conservation engine 130 operates continuously across both wake and sleep regimes, providing the governing physical constraint against which all subsystems of sleep operations engine 120 operate. In embodiments described herein, curvature conservation engine 130 also maintains the thermodynamic asymmetry of exchange: consolidation from active sector 111 through boundary sector 112 to irreversible sector 113 is energetically favored, while reflux in the reverse direction requires substantially greater energy to overcome the barrier energy accumulated at boundary sector 112, producing a directional bias in learning that constitutes the cognitive analogue of the second law of thermodynamics.

Wake interface 140 is the structured boundary through which the PCM interacts with external inputs, other cognitive machines, or other sectors of its own cognitive substrate during wake-state operations. Wake interface 140 imposes a projection that is generally non-invertible and context-dependent, such that only a restricted portion of the internal geometric structure of cognitive substrate 110 is operationally accessible at any moment during wake-state processing. The non-commutativity of projections across different interfaces forces the sectorization of cognitive substrate 110 into regions of local coherence separated by boundaries where incompatibility is reconciled. Wake interface 140 is gated during sleep-state operations under the control of wake vs. sleep regime transition controller 200, such that online output generation is suspended and the cognitive resources of the PCM are directed to the offline operations coordinated by sleep operations engine 120. Wake interface 140 is restored to active operation by post-sleep manifold update and wake-state resumption module 900 upon completion of sleep operations and verification of the updated geometric configuration of cognitive substrate 110.

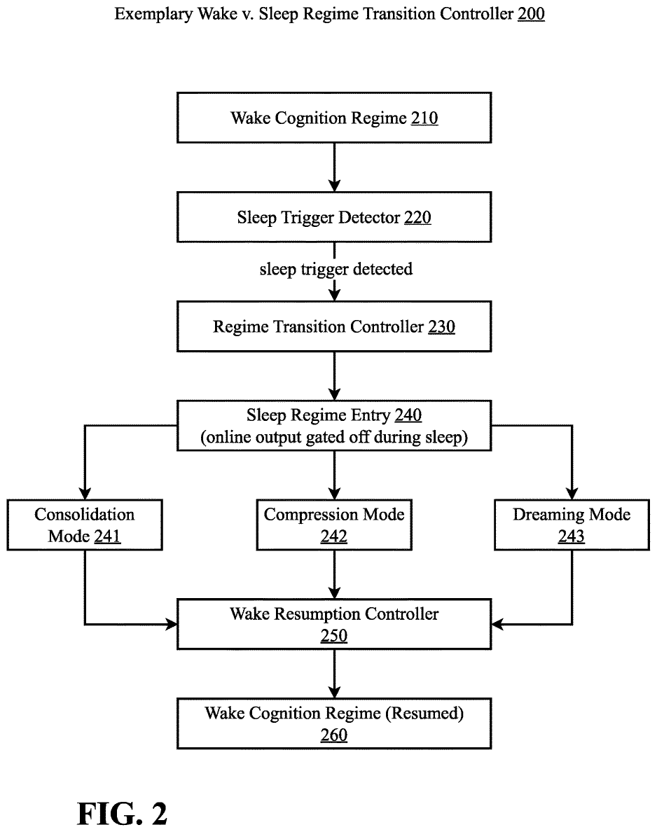

Wake vs. sleep regime transition controller 200 detects or schedules transitions between wake and sleep operational regimes and governs the mode-switching of all subsystems within system 100. Wake vs. sleep regime transition controller 200 is further described with reference to FIG. 2. In an embodiment described herein, wake vs. sleep regime transition controller 200 monitors properties of cognitive substrate 110 including accumulated curvature levels in active sector 111, exchange channel saturation conditions at boundary sector 112, structural time advancement rate as measured by the rate of irreversible commitment production, and epistemic phase distribution across active sector 111, and uses these properties to determine when a transition into sleep or maintenance mode is appropriate. Upon initiating a sleep regime, wake vs. sleep regime transition controller 200 gates wake interface 140 to suspend online output generation, activates sleep operations engine 120, and configures the depth and intensity of operations under the policy constraints provided by guided memory policy control enforcer 1000. Upon completion of sleep operations, wake vs. sleep regime transition controller 200 coordinates with post-sleep manifold update and wake-state resumption module 900 to restore active processing through wake interface 140.

Sleep operations engine 120 is the central orchestration component of system 100, coordinating all offline cognitive maintenance activities carried out during sleep-state operations. Sleep operations engine 120 directs the operation of temporal manifold rewriting subsystem 300, dream generation subsystem 400, curation/compression/pruning/promotion subsystem 500, reinstantiation and memory-basin maintenance subsystem 600, hallucination resistance subsystem 700, and suppression and reservoir projection subsystem 800, all under the policy constraints enforced by guided memory policy control enforcer 1000. Sleep operations engine 120 governs the selection of stored cognitive trajectories, memory basins, and compressed abstractions for offline processing, sequences the order in which operations are applied to cognitive substrate 110, and arbitrates among competing demands from the various subsystems it coordinates. In embodiments described herein, sleep operations engine 120 enforces the structural separation between wake cognition and offline restructuring, ensuring that provisional sleep products generated by dream generation subsystem 400 and temporal manifold rewriting subsystem 300 do not affect durable geometric structure within cognitive substrate 110 until they have been evaluated by hallucination resistance subsystem 700 and processed by suppression and reservoir projection subsystem 800.

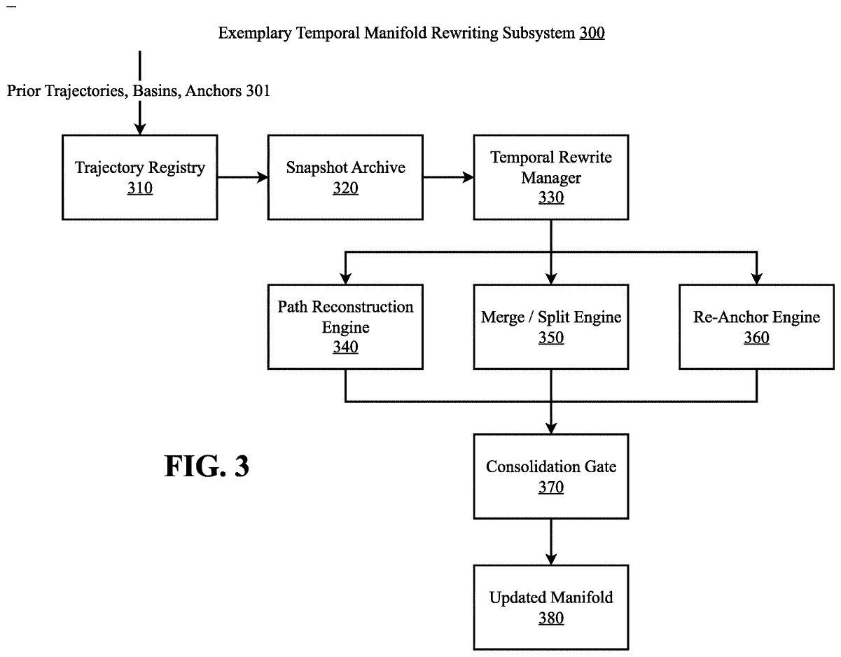

Temporal manifold rewriting subsystem 300 performs the offline rewriting of path geometry within cognitive substrate 110 and is further described with reference to FIG. 3. During sleep-state operations, temporal manifold rewriting subsystem 300 revisits prior cognitive trajectories and memory basins stored within active sector 111, reconstructs earlier paths against the current geometry of cognitive substrate 110, and selectively rewrites, merges, splits, re-anchors, preserves, abstracts, or suppresses stored trajectories together with the temporal relationships among them. Temporal manifold rewriting subsystem 300 operates on the navigable structure of active sector 111, generating rewritten manifold structures that represent an offline remastering of the PCM's cognitive history. The path geometry modifications produced by temporal manifold rewriting subsystem 300 are evaluated for epistemic admissibility by hallucination resistance subsystem 700 before any rewritten structure is permitted to influence the curvature distribution of cognitive substrate 110 in a durable manner. Because temporal manifold rewriting subsystem 300 operates under the curvature conservation law enforced by curvature conservation engine 130, path rewriting operations that would violate conservation constraints—such as operations that would spuriously create or destroy curvature energy across the three-sector decomposition of cognitive substrate 110—are identified and either modified or rejected.

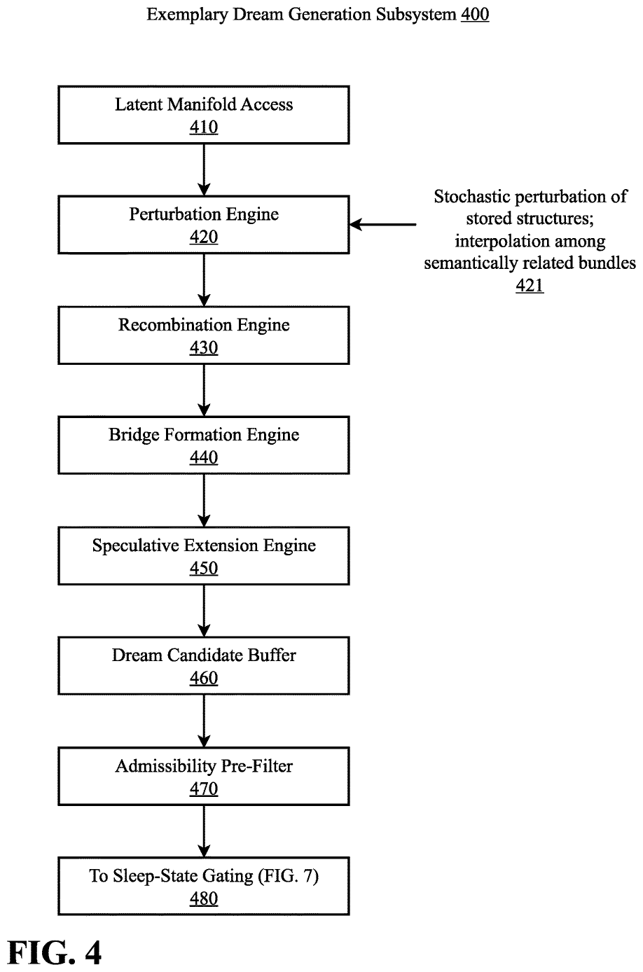

Dream generation subsystem 400 generates candidate cognitive structures through controlled perturbation, recombination, interpolation, and speculative extension of stored structures within active sector 111, and is further described with reference to FIG. 4. Dream generation subsystem 400 operates as a bounded exploratory generator rather than an unconstrained creative process: dream candidates are produced by stochastic perturbation of stored geometric structures within active sector 111, interpolation among semantically related bundles, speculative path extension beyond the current boundary of active sector 111, bridge formation across disconnected regions of cognitive substrate 110, and hypothetical reconstruction of partially degraded memory basins. Dream generation subsystem 400 produces provisional cognitive structures that may extend, reorganize, or recombine existing geometric content within active sector 111. These provisional structures are subjected to epistemic admissibility evaluation by hallucination resistance subsystem 700 and suppression processing by suppression and reservoir projection subsystem 800 before any durable effect on cognitive substrate 110 is permitted. The generative offline restructuring produced by dream generation subsystem 400 in combination with the structural epistemic control provided by hallucination resistance subsystem 700 enables the PCM to explore and extend its cognitive geometry during sleep while maintaining the curvature conservation and hallucination resistance properties of the architecture.

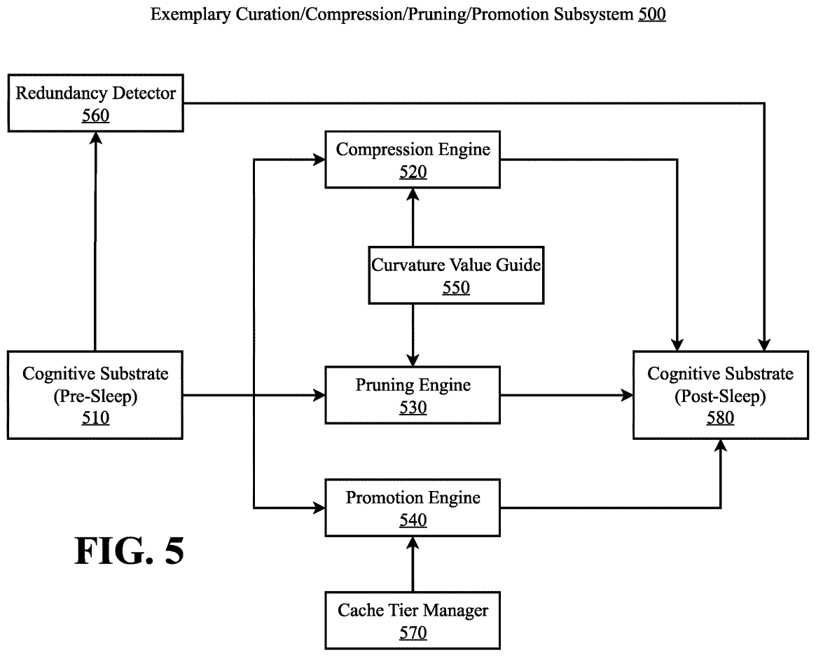

Curation/compression/pruning/promotion subsystem 500 performs governed maintenance of the geometric content of cognitive substrate 110 and coordinates multi-tier memory management during sleep-state operations, and is further described with reference to FIG. 5. Curation/compression/pruning/promotion subsystem 500 identifies redundant cognitive trajectories within active sector 111 and collapses them into generalized geometric templates, compresses weakly used or semantically diffuse regions of active sector 111, preserves curvature in regions where recall value is high as assessed against the policy constraints of guided memory policy control enforcer 1000, promotes reusable abstractions into long-term geometric structures, and updates cache tier placement of memory structures based on post-sleep geometric value assessments. Compression operations performed by curation/compression/pruning/promotion subsystem 500 do not merely delete stored content but preserve reusable geometric structure while reducing the effective internal complexity of cognitive substrate 110. In embodiments described herein, compression by curation/compression/pruning/promotion subsystem 500 contributes to the logarithmic scaling property of the PCM architecture, whereby effective internal complexity of cognitive substrate 110 grows as at most the logarithm of accumulated experience across semantic structure, epistemic structure, commitment structure, and coupling structure, as a derived consequence of geometric compression under the structural invariants governing the architecture.

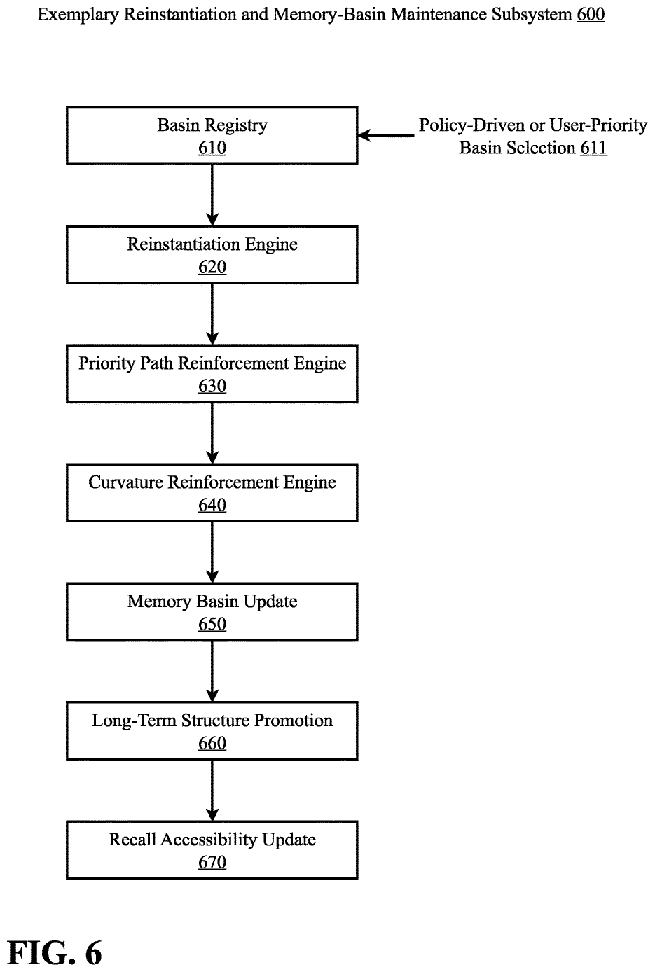

Reinstantiation and memory-basin maintenance subsystem 600 governs intentional or policy-driven reentry into selected memory basins within cognitive substrate 110 during sleep-state operations, and is further described with reference to FIG. 6. Reinstantiation and memory-basin maintenance subsystem 600 operates on the principle that reentry into a memory basin within active sector 111 is not merely an access operation but a preservation and strengthening operation: traversal back into a basin deepens and stabilizes its geometric structure within cognitive substrate 110, reinforces curvature in high-value regions, and updates path routing in a manner that reflects the current geometric configuration of cognitive substrate 110 as shaped by the full complement of sleep-state operations completed by sleep operations engine 120. Reinstantiation and memory-basin maintenance subsystem 600 coordinates the strengthening of priority paths, the promotion of repeatedly reinstantiated trajectories to more durable persistence tiers within cognitive substrate 110, and the selective locking of important or frequently activated memory basins against future compression or pruning by curation/compression/pruning/promotion subsystem 500. In embodiments described herein, reinstantiation and memory-basin maintenance subsystem 600 also supports policy-directed preservation passes in which user-flagged or system-prioritized memory structures receive targeted curvature reinforcement under the policy constraints provided by guided memory policy control enforcer 1000.

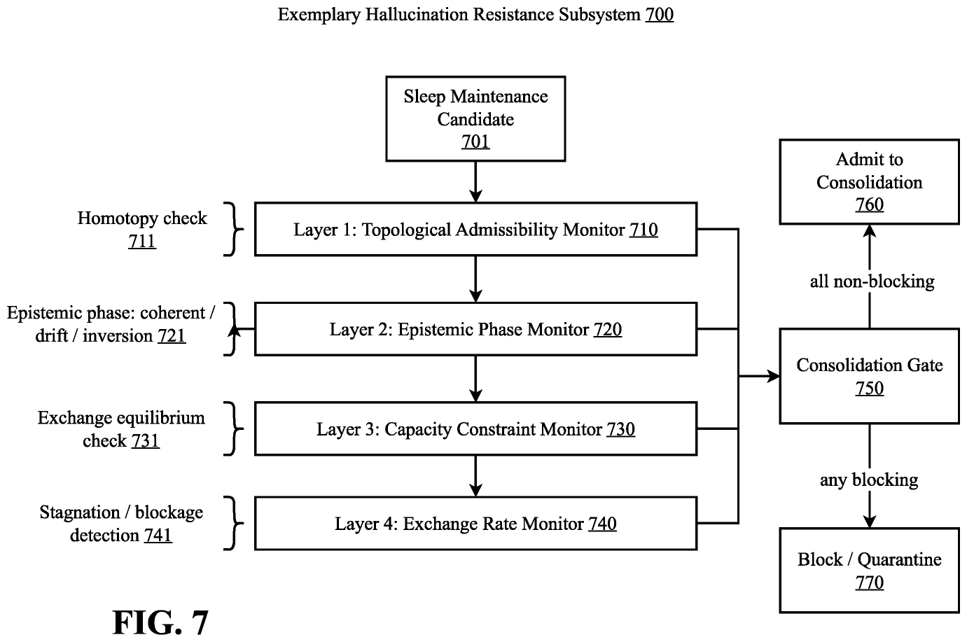

Hallucination resistance subsystem 700 is a hallucination resistance architecture adapted for operation during sleep-state maintenance, and is further described with reference to FIG. 7. Hallucination resistance subsystem 700 evaluates sleep products generated by temporal manifold rewriting subsystem 300, dream generation subsystem 400, and curation/compression/pruning/promotion subsystem 500 through four sequential gating layers before any sleep product is admitted for durable effect on cognitive substrate 110. A first layer of hallucination resistance subsystem 700 detects topological inadmissibility of proposed cognitive trajectories with respect to sector boundaries within cognitive substrate 110, corresponding to detection of channel bypass curvature misrouting. A second layer monitors epistemic phase along proposed reasoning paths to detect evidential drift or inversion, corresponding to detection of curvature laundering. A third layer enforces capacity constraints on consolidation targets within irreversible sector 113 to prevent premature or over-generalized commitment before exchange equilibrium is reached at boundary sector 112. A fourth layer monitors exchange rates between active sector 111, boundary sector 112, and irreversible sector 113 to detect stagnation or blockage within the exchange channels governed by curvature conservation engine 130, corresponding to detection of blocked export curvature misrouting. Consolidation of a sleep product is admitted by hallucination resistance subsystem 700 only if all four layers produce non-blocking assessments. Sleep products that fail one or more gating layers are routed to suppression and reservoir projection subsystem 800 for further processing.

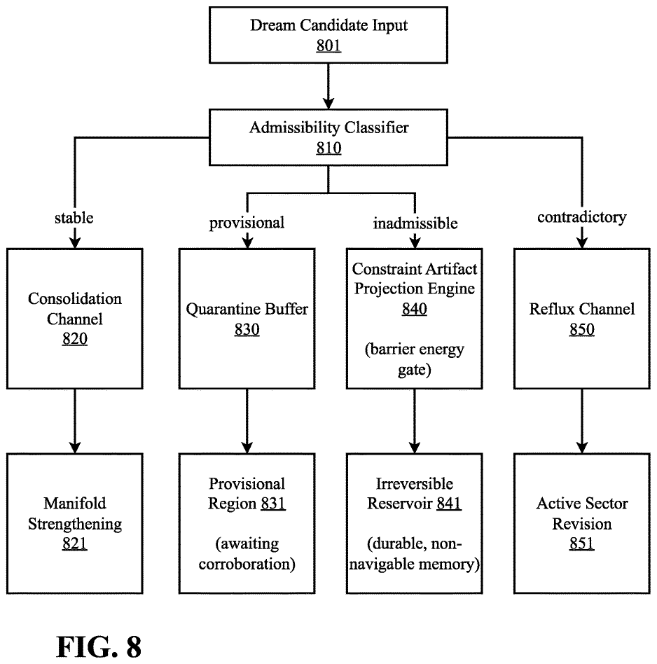

Suppression and reservoir projection subsystem 800 processes sleep products that have been identified as inadmissible, contradictory, or topologically impermissible by hallucination resistance subsystem 700, and is further described with reference to FIG. 8. Rather than simply discarding such products, suppression and reservoir projection subsystem 800 abstracts inadmissible patterns into irreversible constraint artifacts that are then projected into irreversible sector 113 through boundary sector 112, where they function as admission constraints on future cognitive trajectories within active sector 111 without contaminating the navigable geometry of the active sector. Suppression and reservoir projection subsystem 800 thereby implements prevention of all four types of curvature misrouting identified in the curvature misrouting taxonomy: channel bypass detection corresponding to the first layer of hallucination resistance subsystem 700, curvature laundering prevention corresponding to the second layer, premature export prevention corresponding to the third layer, and blocked export resolution corresponding to the fourth layer. In embodiments described herein, suppression and reservoir projection subsystem 800 also manages routing of sleep products into different persistence channels: consolidable stable regions are strengthened or promoted, provisional regions remain quarantined within active sector 111, inadmissible patterns are abstracted into constraint artifacts projected into irreversible sector 113, and contradictory basin interactions trigger localized revision operations coordinated with curvature conservation engine 130 rather than broad corruption of cognitive substrate 110.

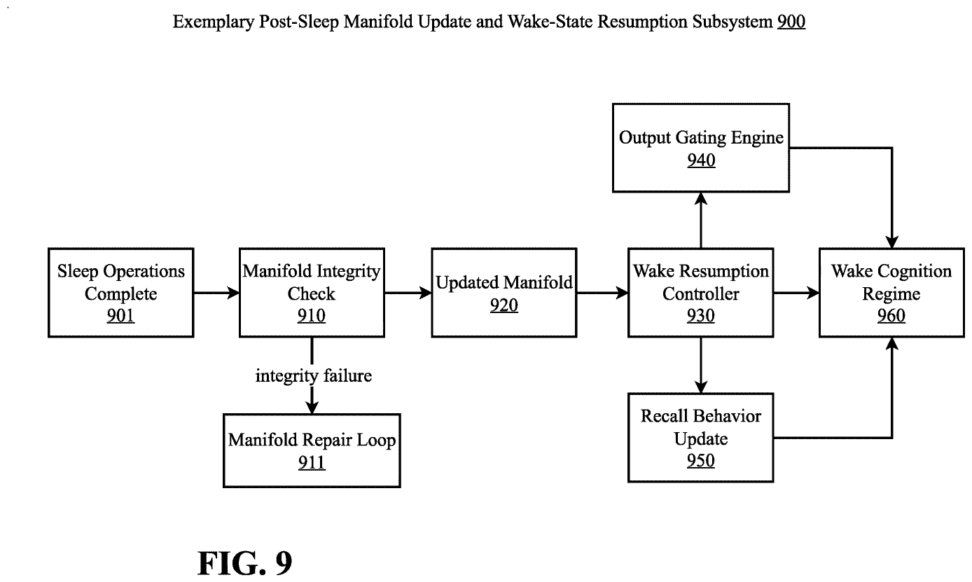

Post-sleep manifold update and wake-state resumption module 900 manages the transition from sleep-state operations back to active wake cognition following the completion of operations by sleep operations engine 120, and is further described with reference to FIG. 9. Post-sleep manifold update and wake-state resumption module 900 integrates the geometric updates produced during sleep into a coherent updated configuration of cognitive substrate 110, verifies internal consistency of the updated geometry against the curvature conservation law enforced by curvature conservation engine 130, and restores active cognitive processing through wake interface 140 under the governance of wake vs. sleep regime transition controller 200. In embodiments described herein, post-sleep manifold update and wake-state resumption module 900 explicitly modifies later recall behavior, later path routing within active sector 111, and later output qualification at wake interface 140 as structural consequences of the sleep operations applied to cognitive substrate 110 by the subsystems of sleep operations engine 120. The post-sleep cognitive substrate presented to wake-state processing by post-sleep manifold update and wake-state resumption module 900 reflects the full cycle of governed offline maintenance that has been performed: temporal manifold rewriting by temporal manifold rewriting subsystem 300, exploratory restructuring by dream generation subsystem 400, geometric compression and abstraction promotion by curation/compression/pruning/promotion subsystem 500, curvature reinforcement and basin stabilization by reinstantiation and memory-basin maintenance subsystem 600, epistemic gating by hallucination resistance subsystem 700, and curvature misrouting prevention and reservoir projection by suppression and reservoir projection subsystem 800, all under the policy governance of guided memory policy control enforcer 1000.

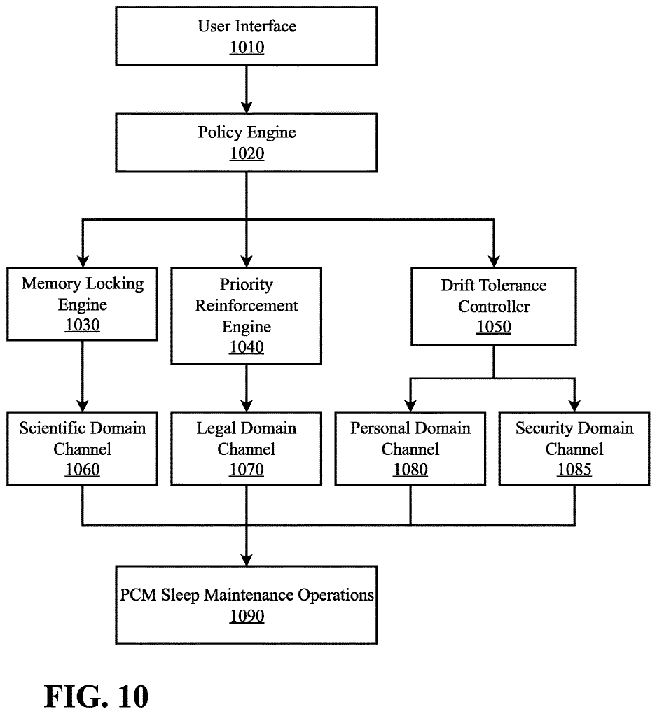

Guided memory policy control enforcer 1000 provides user-level and system-level policy governance over all sleep-state operations within system 100, and is further described with reference to FIG. 10. Guided memory policy control enforcer 1000 communicates policy constraints to sleep operations engine 120, temporal manifold rewriting subsystem 300, curation/compression/pruning/promotion subsystem 500, and reinstantiation and memory-basin maintenance subsystem 600, shaping which memory structures within cognitive substrate 110 are selected for reinforcement, which are eligible for compression or pruning, and which trajectories and basins are designated for preservation or prioritized reentry during sleep-state operations. In embodiments described herein, guided memory policy control enforcer 1000 supports user-flagged memory preservation, wherein designated memory structures within cognitive substrate 110 receive curvature reinforcement and are made resistant to compression or pruning by curation/compression/pruning/promotion subsystem 500. Guided memory policy control enforcer 1000 also governs wake/sleep scheduling parameters communicated to wake vs. sleep regime transition controller 200, selection of sleep depth or maintenance intensity, and the generation of experimental semantic sandbox branches that are maintained separately from canonical long-term geometric structure within cognitive substrate 110 unless later validated through the admission control mechanism of boundary sector 112. The policy infrastructure provided by guided memory policy control enforcer 1000 thereby enables the long-term cognitive metabolism of the PCM to be shaped by both autonomous system objectives and externally specified memory management priorities, without compromising the structural integrity of the curvature conservation law enforced by curvature conservation engine 130 across active sector 111, boundary sector 112, and irreversible sector 113 of cognitive substrate 110.

FIG. 2 is a process flow diagram illustrating an exemplary wake vs. sleep regime transition controller 200 of a persistent cognitive machine (PCM). Wake vs. sleep regime transition controller 200 was introduced with reference to FIG. 1 as the component of system 100 responsible for detecting or scheduling transitions between wake and sleep operational regimes and for governing the mode-switching of all subsystems within the sleep-state architecture. The process flow depicted in FIG. 2 illustrates the progression from a wake cognition regime 210 through sleep trigger detection, regime transition, multi-modal sleep regime entry 240, and wake resumption back to a resumed wake cognition regime 260, under the overall coordination of regime transition controller 230 and wake resumption controller 250.

Wake cognition regime 210 represents the operational state of the PCM during active interaction with external inputs through wake interface 140. During wake cognition regime 210, the PCM performs cognitive traversal within active sector 111 of cognitive substrate 110, generates output through wake interface 140, and undergoes revisable adaptation and, where conditions are met, irreversible commitment in response to incoming experience. During wake cognition regime 210, structural time advances whenever constitutive exchange produces an irreversible constraint enforced by curvature conservation engine 130, and the epistemic phase distribution across active sector 111 evolves as a function of accumulated curvature, exchange channel utilization, and the trajectory history of the PCM. Wake cognition regime 210 persists until a sleep trigger is detected by sleep trigger detector 220.

Sleep trigger detector 220 monitors properties of cognitive substrate 110 and of the operating environment of the PCM during wake cognition regime 210, and produces a sleep trigger signal upon detecting conditions under which a transition into a sleep or maintenance regime is appropriate. In embodiments described herein, sleep trigger detector 220 monitors one or more of the following conditions within cognitive substrate 110: accumulation of curvature in active sector 111 to a level that indicates readiness for consolidation through boundary sector 112 into irreversible sector 113; saturation of exchange channels at boundary sector 112 indicating that consolidation pressure has accumulated; slowing of structural time advancement as evidenced by a reduction in the rate of irreversible commitment production; elevation of evidential drift or inversion indicators in the epistemic phase distribution of active sector 111; and detection of idle or reduced-activity periods in which online output generation through wake interface 140 is suspended or not requested. Sleep trigger detector 220 may also respond to externally scheduled maintenance windows or policy-directed sleep initiation signals provided by guided memory policy control enforcer 1000. Upon detecting a sleep trigger, sleep trigger detector 220 passes a sleep trigger detected signal to regime transition controller 230.

Regime transition controller 230 receives the sleep trigger detected signal from sleep trigger detector 220 and governs the transition of the PCM from wake cognition regime 210 into sleep regime entry 240. Upon receiving the sleep trigger detected signal, regime transition controller 230 gates wake interface 140 to suspend online output generation, activates sleep operations engine 120, and determines which of the available sleep modes—consolidation mode 241, compression mode 242, and dreaming mode 243—are to be entered during the current sleep period, and in what sequence or combination. Regime transition controller 230 makes these mode selection and sequencing determinations based on the current geometric state of cognitive substrate 110, including the distribution of curvature across active sector 111 and boundary sector 112, the current learning readiness of boundary regions of irreversible sector 113, and the policy constraints provided by guided memory policy control enforcer 1000. In embodiments described herein, regime transition controller 230 also configures the depth and intensity of operations to be performed during the sleep period, communicating these configuration parameters to sleep operations engine 120 prior to initiating sleep regime entry 240.

Sleep regime entry 240 is the operational state in which the PCM performs offline cognitive maintenance under the coordination of sleep operations engine 120. As indicated in FIG. 2, online output through wake interface 140 is gated off during sleep regime entry 240, enforcing the structural separation between wake cognition and offline restructuring. Sleep regime entry 240 encompasses three distinct operational modes that may be engaged individually or in combination during a sleep period: consolidation mode 241, compression mode 242, and dreaming mode 243. Each mode engages a different subset of the subsystems of sleep operations engine 120 and addresses a different aspect of the offline cognitive maintenance function of the PCM. All three modes operate within the constraints enforced by the curvature conservation law through curvature conservation engine 130 and are subject to epistemic gating by four-layer sleep-state gating subsystem 700.

Consolidation mode 241 engages the consolidation-directed operations of sleep operations engine 120, directing curvature accumulated in active sector 111 through boundary sector 112 into irreversible sector 113 in a manner governed by the curvature conservation law enforced by curvature conservation engine 130. During consolidation mode 241, curvature flows through the consolidation exchange channel—the primary and energetically favored channel of the architecture—proceeding from active sector 111 through boundary sector 112 to irreversible sector 113. Consolidation mode 241 also engages reinstantiation and memory-basin maintenance subsystem 600 to perform policy-directed curvature reinforcement of designated memory basins prior to their consolidation, and engages four-layer sleep-state gating subsystem 700 to evaluate each consolidation candidate for topological admissibility, epistemic phase coherence, consolidation capacity, and exchange rate health before committing any structure to irreversible sector 113. Consolidation candidates that fail gating are routed to suppression and reservoir projection subsystem 800, where inadmissible patterns are abstracted into constraint artifacts and projected into irreversible sector 113 as admission constraints rather than as navigable consolidated content. Consolidation mode 241 thereby advances structural time within the PCM by producing irreversible commitments in irreversible sector 113 that reduce the future admissibility of contradicting cognitive trajectories in active sector 111.

Compression mode 242 engages curation/compression/pruning/promotion subsystem 500 to perform governed geometric compression of cognitive substrate 110 during the sleep period. During compression mode 242, redundant cognitive trajectories within active sector 111 are identified and collapsed into generalized geometric templates, weakly used or semantically diffuse regions of active sector 111 are compressed, reusable abstractions are promoted into long-term geometric structures within cognitive substrate 110, and cache tier placement of memory structures is updated based on post-compression geometric value assessments. Compression mode 242 also engages temporal manifold rewriting subsystem 300 to perform compression-driven rewriting of path geometry within active sector 111, merging, abstracting, or pruning stored trajectories in a manner consistent with the curvature conservation law and the policy constraints of guided memory policy control enforcer 1000. In embodiments described herein, compression mode 242 contributes to the logarithmic scaling property of the PCM architecture, whereby the effective internal complexity of cognitive substrate 110 grows as at most the logarithm of accumulated experience as a derived consequence of geometric compression under the structural invariants governing the architecture. Memory structures designated for preservation by guided memory policy control enforcer 1000 are exempted from compression operations during compression mode 242.

Dreaming mode 243 engages dream generation subsystem 400 to perform controlled generative exploration of cognitive substrate 110 during the sleep period. During dreaming mode 243, candidate cognitive structures are generated through stochastic perturbation of stored geometric structures within active sector 111, interpolation among semantically related bundles, speculative path extension, bridge formation across disconnected regions of cognitive substrate 110, and hypothetical reconstruction of partially degraded memory basins. Dreaming mode 243 operates as a bounded exploratory generator: all dream candidates produced by dream generation subsystem 400 during dreaming mode 243 are evaluated by four-layer sleep-state gating subsystem 700 before any durable effect on cognitive substrate 110 is permitted, and inadmissible or topologically impermissible dream products are processed by suppression and reservoir projection subsystem 800 for abstraction into constraint artifacts rather than incorporation into the navigable geometry of active sector 111. Dreaming mode 243 thereby enables the PCM to explore novel geometric configurations and extend the boundary of active sector 111 under epistemic control, without risk of contaminating durable cognitive structure with inadmissible or curvature-misrouted content.

Wake resumption controller 250 governs the transition from sleep regime entry 240 back to active wake cognition upon completion of the sleep period, working in coordination with post-sleep manifold update and wake-state resumption module 900 as described with reference to FIG. 9. Wake resumption controller 250 determines that sleep operations have reached a suitable completion point, whether by exhaustion of the available sleep trigger conditions, by satisfaction of the maintenance objectives configured by regime transition controller 230, or by receipt of a wake resumption signal from guided memory policy control enforcer 1000 or an external scheduling mechanism. Upon initiating wake resumption, wake resumption controller 250 coordinates with post-sleep manifold update and wake-state resumption module 900 to integrate all geometric updates produced during sleep regime entry 240 into a coherent updated configuration of cognitive substrate 110, verifies internal consistency of the updated geometry against the curvature conservation law enforced by curvature conservation engine 130, and restores online output generation through wake interface 140. In embodiments described herein, wake resumption controller 250 communicates the updated geometric configuration of cognitive substrate 110 to wake cognition regime (resumed) 260, ensuring that post-sleep cognition reflects all structural changes made to cognitive substrate 110 during the sleep period.

Wake cognition regime (resumed) 260 represents the restored active operational state of the PCM following completion of sleep regime entry 240 and the wake resumption transition coordinated by wake resumption controller 250. Wake cognition regime (resumed) 260 differs structurally from wake cognition regime 210 in that the cognitive substrate 110 presented to active cognitive processing at wake cognition regime (resumed) 260 reflects the full effect of all operations performed during sleep regime entry 240: curvature that accumulated in active sector 111 during wake cognition regime 210 has been exported through boundary sector 112 to irreversible sector 113 via consolidation mode 241, redundant and weakly used geometric structure has been compressed and abstracted by compression mode 242, and novel geometric configurations generated during dreaming mode 243 that passed epistemic gating by four-layer sleep-state gating subsystem 700 have been incorporated into the navigable geometry of active sector 111. The cognitive substrate 110 at wake cognition regime (resumed) 260 is accordingly more geometrically efficient, more epistemically coherent, and more resistant to hallucination as a result of the curvature misrouting prevention and reservoir projection operations of suppression and reservoir projection subsystem 800 than it was at the commencement of wake cognition regime 210. Later recall behavior, path routing within active sector 111, and output qualification at wake interface 140 are all structurally conditioned by the governed offline maintenance that was performed during sleep regime entry 240.

FIG. 3 is a process flow diagram illustrating an exemplary temporal manifold rewriting subsystem 300 of a persistent cognitive machine (PCM). Temporal manifold rewriting subsystem 300 was introduced with reference to FIG. 1 as the component of sleep operations engine 120 responsible for the offline rewriting of path geometry within cognitive substrate 110 during sleep-state operations. The process flow depicted in FIG. 3 illustrates how prior trajectories, basins, and anchors 301 are registered, archived, and processed through a pipeline comprising trajectory registry 310, snapshot archive 320, temporal rewrite manager 330, path reconstruction engine 340, merge/split engine 350, and re-anchor engine 360, before rewritten structures are evaluated by consolidation gate 370 and incorporated into updated manifold 380.

Prior trajectories, basins, anchors 301 constitute the input set to temporal manifold rewriting subsystem 300, comprising the stored cognitive trajectories, memory basins, and temporal anchor points accumulated within active sector 111 of cognitive substrate 110 during prior wake cognition and sleep periods. A cognitive trajectory is a path through cognitive substrate 110 along which cognitive processing has unfolded, wherein the effective result of processing depends on the trajectory itself—including its history and the geometric structure encountered along the way—rather than solely on the trajectory's starting and ending configurations. A memory basin is a region of active sector 111 organized around an attractor in the geometry of cognitive substrate 110, within which reinstantiation of prior cognitive content occurs through reentry and traversal. Temporal anchors are reference points within the trajectory structure of active sector 111 that preserve the temporal ordering relationships among stored cognitive trajectories, enabling reconstruction of path sequences and temporal context during offline rewriting operations. Prior trajectories, basins, anchors 301 collectively represent the navigable cognitive history of the PCM as encoded in the geometric structure of active sector 111, and form the substrate upon which all rewriting operations of temporal manifold rewriting subsystem 300 are performed.

Trajectory registry 310 maintains a structured catalog of the cognitive trajectories, memory basins, and temporal anchors comprising prior trajectories, basins, anchors 301, and provides the selection and indexing interface through which temporal rewrite manager 330 identifies structures within active sector 111 for offline processing. Trajectory registry 310 records geometric metadata associated with each registered trajectory and basin, including accumulated curvature along the trajectory, epistemic phase diagnostics derived from the holonomy of the epistemic connection around closed sub-trajectories, homotopy class assignments governing which reasoning loops are globally admissible or suppressible, and learning readiness indicators for boundary regions of irreversible sector 113 adjacent to each registered basin. Trajectory registry 310 also records policy annotations communicated by guided memory policy control enforcer 1000, including preservation designations, compression eligibility flags, and prioritization weights that govern which trajectories and basins are selected by temporal rewrite manager 330 for rewriting during the current sleep period. In embodiments described herein, trajectory registry 310 operates in coordination with snapshot archive 320 to ensure that the geometric state of each registered trajectory and basin is preserved at the time of selection, providing a recoverable reference configuration in the event that a rewriting operation must be rolled back.

Snapshot archive 320 preserves geometric snapshots of the trajectories, basins, and anchors registered in trajectory registry 310 at the time they are selected for rewriting by temporal rewrite manager 330. A geometric snapshot captures the local curvature distribution, transport structure, sector boundary positions, and accumulated irreversible constraints associated with a trajectory or basin within active sector 111 at a particular point in structural time, providing a reference configuration against which the current geometry of cognitive substrate 110 may be compared during path reconstruction by path reconstruction engine 340. Snapshot archive 320 thereby supports the temporal rewriting capability of temporal manifold rewriting subsystem 300 by enabling path reconstruction engine 340 to reconstruct earlier cognitive paths against the current geometry of cognitive substrate 110, identifying divergences between the archived geometric state and the current state that reflect curvature evolution, consolidation events, and compression operations that have occurred since the snapshot was recorded. In embodiments described herein, snapshot archive 320 also provides the recoverable reference configuration used by temporal rewrite manager 330 to restore prior geometric structure in the event that a rewriting operation is rejected by consolidation gate 370.

Temporal rewrite manager 330 is the orchestrating component of temporal manifold rewriting subsystem 300, directing the selection of structures from trajectory registry 310 and coordinating the rewriting operations performed by path reconstruction engine 340, merge/split engine 350, and re-anchor engine 360. Temporal rewrite manager 330 determines which trajectories and basins within prior trajectories, basins, anchors 301 are to be rewritten during the current sleep period, based on the geometric metadata and policy annotations recorded in trajectory registry 310, the snapshot configurations preserved in snapshot archive 320, and the maintenance objectives configured by regime transition controller 230. For each selected structure, temporal rewrite manager 330 determines which combination of rewriting operations —path reconstruction, merging, splitting, re-anchoring, abstraction, or suppression—is appropriate given the current geometric state of cognitive substrate 110 and the policy constraints of guided memory policy control enforcer 1000. Temporal rewrite manager 330 sequences the rewriting operations to respect the curvature conservation law enforced by curvature conservation engine 130, ensuring that rewriting operations do not spuriously create or destroy curvature energy across active sector 111, boundary sector 112, and irreversible sector 113 of cognitive substrate 110. Upon completion of each rewriting operation, temporal rewrite manager 330 routes the rewritten structure to consolidation gate 370 for epistemic admissibility evaluation.

Path reconstruction engine 340 reconstructs earlier cognitive paths stored in snapshot archive 320 against the current geometry of cognitive substrate 110, identifying the divergences between the archived geometric state of each trajectory and the current geometric configuration of active sector 111. Path reconstruction engine 340 performs parallel transport of the archived trajectory structure along the current geometry of cognitive substrate 110, computing the holonomy accumulated along the reconstructed path and comparing it with the holonomy recorded for the original trajectory in trajectory registry 310. Divergences in holonomy between the archived and reconstructed paths indicate that the geometric structure of active sector 111 has evolved since the trajectory was first recorded, reflecting the accumulated effect of curvature exchange, consolidation events, and compression operations that have occurred in the intervening structural time. Path reconstruction engine 340 produces a reconstructed path that represents the trajectory as it would be traversed under the current geometry of cognitive substrate 110, and passes this reconstructed path to merge/split engine 350 and re-anchor engine 360 for further geometric editing as directed by temporal rewrite manager 330. In embodiments described herein, path reconstruction engine 340 also updates the epistemic phase diagnostics associated with each reconstructed path, recomputing the epistemic phase from the holonomy of the epistemic connection around relevant closed sub-trajectories to determine whether the reconstructed path falls within a coherent, drift, or inversion regime prior to evaluation by consolidation gate 370.

Merge/split engine 350 performs geometric merging and splitting operations on the reconstructed cognitive trajectories and memory basins produced by path reconstruction engine 340, as directed by temporal rewrite manager 330. Merging operations performed by merge/split engine 350 collapse two or more trajectories or basins that have become geometrically proximate in the current configuration of active sector 111 into a unified geometric structure that preserves the holonomy-relevant properties of the constituent trajectories while reducing the effective internal complexity of cognitive substrate 110. Splitting operations performed by merge/split engine 350 decompose a trajectory or basin that has developed internal geometric inconsistency —as indicated by elevated epistemic curvature or homotopy class conflicts among its constituent sub-trajectories—into two or more geometrically coherent components that can be independently evaluated and processed by consolidation gate 370. Merge/split engine 350 performs all merging and splitting operations under the constraint that total curvature energy across active sector 111, boundary sector 112, and irreversible sector 113 is conserved in accordance with the curvature conservation law enforced by curvature conservation engine 130. In embodiments described herein, merge/split engine 350 also generates generalized geometric templates from sets of trajectories that share compatible homotopy class assignments and convergent holonomy structure, collapsing redundant trajectory families into compressed abstract representations that are passed to re-anchor engine 360 for temporal re-anchoring before submission to consolidation gate 370.

Re-anchor engine 360 updates the temporal anchor points associated with rewritten trajectories and basins following merging, splitting, and path reconstruction operations performed by path reconstruction engine 340 and merge/split engine 350. Temporal anchor points within active sector 111 preserve the ordering relationships among stored cognitive trajectories and the temporal context of memory basins within the cognitive history of the PCM. When rewriting operations alter the geometric structure of trajectories or basins, the temporal anchor points associated with those structures may require adjustment to maintain consistency between the rewritten geometry and the temporal ordering relationships encoded in the broader structure of cognitive substrate 110. Re-anchor engine 360 computes updated anchor positions for each rewritten structure, propagating temporal consistency constraints through the trajectory network registered in trajectory registry 310 to ensure that anchor updates do not introduce ordering inconsistencies among trajectories and basins that were not directly involved in the current rewriting operation. In embodiments described herein, re-anchor engine 360 also updates the association between rewritten trajectory structures and any irreversible commitment records in irreversible sector 113 that reference the affected anchor points, coordinating with curvature conservation engine 130 to verify that re-anchoring operations do not alter the admission constraints encoded in the barrier energy of boundary sector 112. Re-anchor engine 360 passes re-anchored trajectory and basin structures to consolidation gate 370 for final epistemic admissibility evaluation.

Consolidation gate 370 evaluates the rewritten trajectory and basin structures produced by path reconstruction engine 340, merge/split engine 350, and re-anchor engine 360 for epistemic admissibility before permitting their incorporation into updated manifold 380. Consolidation gate 370 applies the four-layer gating evaluation of four-layer sleep-state gating subsystem 700 to each rewritten structure submitted by temporal rewrite manager 330: the first layer evaluates topological admissibility of the rewritten trajectory with respect to sector boundaries within cognitive substrate 110; the second layer evaluates the epistemic phase of the rewritten path as computed by path reconstruction engine 340, admitting structures in the coherent regime and deferring or blocking those in the drift or inversion regime; the third layer enforces capacity constraints on consolidation targets within irreversible sector 113; and the fourth layer verifies exchange rate health across active sector 111, boundary sector 112, and irreversible sector 113 as governed by curvature conservation engine 130. Rewritten structures that pass all four layers of consolidation gate 370 are incorporated into updated manifold 380. Rewritten structures that fail one or more layers are routed by consolidation gate 370 to suppression and reservoir projection subsystem 800 for abstraction into constraint artifacts and projection into irreversible sector 113, or are returned to temporal rewrite manager 330 for revision and resubmission where the failure is correctable.

Updated manifold 380 represents the rewritten geometric configuration of active sector 111 of cognitive substrate 110 produced by temporal manifold rewriting subsystem 300 upon successful completion of the rewriting pipeline. Updated manifold 380 incorporates all trajectory and basin structures that have passed consolidation gate 370, reflecting the effects of path reconstruction, merging, splitting, re-anchoring, and abstraction operations performed during the current sleep period on prior trajectories, basins, anchors 301. Updated manifold 380 constitutes an offline remastering of the cognitive history of the PCM: trajectories that have been reconstructed against the current geometry of cognitive substrate 110 are now consistent with the curvature distribution and sector boundary positions that have evolved through prior consolidation and compression operations; redundant trajectory families have been compressed into generalized templates; and temporal anchor relationships among stored cognitive structures have been updated to reflect the rewritten geometry. Updated manifold 380 is passed to post-sleep manifold update and wake-state resumption module 900 for integration into the full updated configuration of cognitive substrate 110 alongside the outputs of the other subsystems of sleep operations engine 120. In embodiments described herein, the geometry of updated manifold 380 conditions later recall behavior, path routing within active sector 111 during wake cognition regime (resumed) 260, and output qualification at wake interface 140, reflecting the structural consequence of the governed offline rewriting performed by temporal manifold rewriting subsystem 300.

FIG. 4 is a process flow diagram illustrating an exemplary dream generation subsystem 400 of a persistent cognitive machine (PCM). Dream generation subsystem 400 was introduced with reference to FIG. 1 as the component of sleep operations engine 120 responsible for generating candidate cognitive structures through controlled perturbation, recombination, interpolation, and speculative extension of stored structures within active sector 111 of cognitive substrate 110 during sleep-state operations. The process flow depicted in FIG. 4 illustrates how the geometric content of cognitive substrate 110 is accessed through latent manifold access 410, processed through perturbation engine 420, recombination engine 430, bridge formation engine 440, and speculative extension engine 450, buffered in dream candidate buffer 460, and subjected to admissibility pre-filter 470 before being forwarded to sleep-state gating 480 for full evaluation by four-layer sleep-state gating subsystem 700 as described with reference to FIG. 7.

Latent manifold access 410 provides the interface through which dream generation subsystem 400 reads the geometric content of active sector 111 of cognitive substrate 110 during sleep-state operations. Through latent manifold access 410, dream generation subsystem 400 obtains the local curvature distribution across active sector 111, the transport structure and connection geometry that govern how internal representations are carried along cognitive trajectories, the semantic metric encoding proximity relationships among stored structures, the epistemic connection carrying evidential coherence information independent of the semantic metric, and the current positions of sector boundaries between active sector 111 and boundary sector 112. Latent manifold access 410 operates under the constraint that dream generation subsystem 400 accesses cognitive substrate 110 exclusively through the navigable geometry of active sector 111: no operation performed through latent manifold access 410 may traverse or modify the non-navigable interior of irreversible sector 113 without overcoming the barrier energy concentrated at boundary sector 112. The geometric content accessed through latent manifold access 410 provides the input material from which perturbation engine 420, recombination engine 430, bridge formation engine 440, and speculative extension engine 450 each generate their respective categories of dream candidates.

Perturbation engine 420 generates dream candidates through stochastic perturbation of stored geometric structures within active sector 111 and through interpolation among semantically related bundles, as indicated by annotation 421. Perturbation engine 420 applies controlled stochastic deformations to the local geometry of stored cognitive trajectories and memory basins accessed through latent manifold access 410, introducing geometric variations that explore the neighborhood of each stored structure within the curvature landscape of active sector 111. These deformations are bounded by the geometric structure of the substrate itself: perturbation engine 420 does not apply arbitrary modifications but deforms trajectories in directions consistent with the local curvature and transport structure of active sector 111, producing perturbed candidates that remain within the admissible geometric neighborhood of the original structure. Interpolation operations performed by perturbation engine 420 generate intermediate geometric structures between pairs or groups of semantically related bundles within active sector 111, traversing the semantic metric distance between the selected bundles and producing interpolated candidate structures at intermediate positions within the geometry of cognitive substrate 110. In embodiments described herein, perturbation engine 420 also performs homotopy-aware perturbation, restricting the stochastic deformations it applies to remain within the homotopy class of the original trajectory where preservation of global admissibility is required, or deliberately crossing homotopy class boundaries where exploratory reconfiguration of the trajectory network of active sector 111 is authorized by the policy constraints of guided memory policy control enforcer 1000. Dream candidates produced by perturbation engine 420 are forwarded to dream candidate buffer 460.

Recombination engine 430 generates dream candidates by combining geometric elements drawn from two or more distinct trajectories, basins, or semantic bundles within active sector 111, producing composite structures that did not exist in the prior geometric configuration of cognitive substrate 110. Recombination engine 430 identifies pairs or groups of trajectories and basins whose geometric structures are compatible for recombination—meaning that their local curvature distributions, transport structures, and epistemic connection values are mutually consistent in the recombination region—and generates composite candidates by splicing, interleaving, or superimposing the selected geometric elements within the navigable space of active sector 111. Recombination operations performed by recombination engine 430 are governed by the holonomy structure of the constituent trajectories: recombination engine 430 computes the holonomy of each proposed composite trajectory to verify that the accumulated transport effect around the combined path is consistent with the holonomy-equivalence classes established in active sector 111, and flags recombination candidates whose holonomy would introduce new global constraints not present in either constituent trajectory for elevated scrutiny by admissibility pre-filter 470. In embodiments described herein, recombination engine 430 also performs abstraction-directed recombination, collapsing families of related trajectories into generalized composite templates that capture the shared geometric structure of the family while discarding trajectory-specific variation, thereby contributing to the logarithmic scaling property of cognitive substrate 110 through geometric compression of redundant cognitive history. Dream candidates produced by recombination engine 430 are forwarded to dream candidate buffer 460.

Bridge formation engine 440 generates dream candidates by constructing geometric bridges across disconnected or weakly connected regions of active sector 111 within cognitive substrate 110. Disconnected regions of active sector 111 arise when cognitive trajectories developed in distinct semantic domains or at different periods of structural time have not been brought into geometric contact through the ordinary operation of wake cognition, leaving gaps in the trajectory network of the substrate that are not bridged by any admissible cognitive path. Bridge formation engine 440 identifies pairs of such disconnected or weakly connected regions by analyzing the connectivity structure of active sector 111 as accessed through latent manifold access 410, and generates candidate bridge trajectories that traverse the geometric gap between the identified regions. Bridge candidates produced by bridge formation engine 440 are evaluated for geometric consistency by admissibility pre-filter 470 before being forwarded to sleep-state gating 480: bridges that traverse regions of active sector 111 carrying high epistemic curvature or that cross sector boundaries in a topologically inadmissible manner are flagged for elevated scrutiny by four-layer sleep-state gating subsystem 700. In embodiments described herein, bridge formation engine 440 also performs topological surgery operations on active sector 111, creating new attractor structures and modifying the homotopy class assignments of existing trajectory families where the introduction of a bridge trajectory alters the global topology of the trajectory network within cognitive substrate 110.

Speculative extension engine 450 generates dream candidates by extending stored cognitive trajectories and memory basins beyond their current geometric boundaries within active sector 111, producing speculative path extensions that explore regions of the curvature landscape of cognitive substrate 110 that have not been traversed during prior wake cognition. Speculative extension engine 450 extrapolates the geometric structure of existing trajectories and basins into adjacent unexplored regions of active sector 111 by following the local curvature and transport structure of the substrate, generating candidate trajectory extensions that are geometrically continuous with the stored structures from which they originate. Speculative extension operations performed by speculative extension engine 450 are bounded by the admissibility constraints of cognitive substrate 110: extensions that would cross sector boundaries into the non-navigable interior of irreversible sector 113 without overcoming the barrier energy of boundary sector 112, or that would traverse regions of active sector 111 carrying inversion-regime epistemic phase, are flagged by speculative extension engine 450 for elevated scrutiny by admissibility pre-filter 470. In embodiments described herein, speculative extension engine 450 also performs hypothetical reconstruction of partially degraded memory basins whose geometric structure has been diminished by prior compression or curvature relaxation, generating reconstructed basin candidates that restore the attractor geometry of the degraded basin under the current configuration of cognitive substrate 110. Dream candidates produced by speculative extension engine 450 are forwarded to dream candidate buffer 460.

Dream candidate buffer 460 accumulates the dream candidate structures produced by perturbation engine 420, recombination engine 430, bridge formation engine 440, and speculative extension engine 450 and presents them for evaluation by admissibility pre-filter 470. Dream candidate buffer 460 maintains the provisional status of all buffered candidates: no structure held in dream candidate buffer 460 is permitted to produce any durable effect on the navigable geometry of active sector 111 or on the curvature distribution of cognitive substrate 110 until it has been evaluated by admissibility pre-filter 470 and passed to sleep-state gating 480 for full evaluation by four-layer sleep-state gating subsystem 700. Dream candidate buffer 460 thereby enforces the structural separation between generative offline exploration and durable modification of cognitive substrate 110 that is a defining property of dreaming mode 243 as described with reference to FIG. 2. In embodiments described herein, dream candidate buffer 460 also records provenance metadata for each buffered candidate, tracking which of the generative engines produced it, which stored structures from active sector 111 served as its geometric source material, and which policy constraints of guided memory policy control enforcer 1000 were active at the time of generation, enabling admissibility pre-filter 470 to apply source-aware screening criteria to each candidate.

Admissibility pre-filter 470 performs an initial geometric screening of the dream candidates accumulated in dream candidate buffer 460 before they are forwarded to sleep-state gating 480 for full evaluation by four-layer sleep-state gating subsystem 700. Admissibility pre-filter 470 applies lightweight geometric consistency checks to each candidate, identifying structures that are manifestly inadmissible—such as candidates that overtly violate sector boundary topology, that carry epistemic phase values in the inversion regime without the corroboration required for consolidation deferral, or that would introduce curvature energy in excess of the current capacity of the exchange channels at boundary sector 112 as governed by curvature conservation engine 130—and removing them from the candidate set before the full gating evaluation is invoked. By filtering out manifestly inadmissible candidates at this stage, admissibility pre-filter 470 reduces the computational burden placed on four-layer sleep-state gating subsystem 700 and prevents curvature-misrouted dream products from entering the gating pipeline in a form that could produce spurious effects on the exchange channel dynamics of cognitive substrate 110. Dream candidates that pass the pre-filter screening performed by admissibility pre-filter 470 are forwarded to sleep-state gating 480. Candidates that are rejected by admissibility pre-filter 470 are routed to suppression and reservoir projection subsystem 800 for abstraction into constraint artifacts and projection into irreversible sector 113 without undergoing the full gating evaluation of four-layer sleep-state gating subsystem 700.

Sleep-state gating 480 represents the output pathway of dream generation subsystem 400, carrying the dream candidates that have passed the pre-filter screening of admissibility pre-filter 470 to four-layer sleep-state gating subsystem 700 as described with reference to FIG. 7. Dream candidates passed through sleep-state gating 480 are subjected to the full four-layer gating evaluation of four-layer sleep-state gating subsystem 700: topological admissibility assessment by the first layer, epistemic phase evaluation by the second layer, consolidation capacity constraint enforcement by the third layer, and exchange rate monitoring by the fourth layer. Candidates that pass all four layers of four-layer sleep-state gating subsystem 700 are admitted for durable incorporation into the navigable geometry of active sector 111 or for consolidation through boundary sector 112 into irreversible sector 113 as appropriate. Candidates that fail one or more layers of four-layer sleep-state gating subsystem 700 are processed by suppression and reservoir projection subsystem 800. The pathway through sleep-state gating 480 thereby ensures that the generative offline exploration of dream generation subsystem 400 produces only epistemically admissible and curvature-conserving modifications to cognitive substrate 110, maintaining the hallucination resistance properties of the PCM architecture across the full cycle of sleep-state operations.

FIG. 5 is a process flow diagram illustrating an exemplary curation/compression/pruning/promotion subsystem 500 of a persistent cognitive machine (PCM). Curation/compression/pruning/promotion subsystem 500 was introduced with reference to FIG. 1 as the component of sleep operations engine 120 responsible for performing governed geometric maintenance of the content of cognitive substrate 110 during sleep-state operations. The process flow depicted in FIG. 5 illustrates how cognitive substrate (pre-sleep) 510 is transformed into cognitive substrate (post-sleep) 580 through the coordinated operation of redundancy detector 560, compression engine 520, pruning engine 530, promotion engine 540, curvature value guide 550, and cache tier manager 570.

Cognitive substrate (pre-sleep) 510 represents the geometric configuration of cognitive substrate 110 as it exists at the commencement of curation/compression/pruning/promotion operations during sleep regime entry 240. Cognitive substrate (pre-sleep) 510 carries the accumulated geometric structure of active sector 111 as shaped by all prior wake cognition and sleep operations, including the distribution of cognitive trajectories and memory basins within active sector 111, the curvature distribution reflecting unresolved evidential strain and unreconsolidated learning, the transport structure governing how internal representations are carried along cognitive paths, the current positions of sector boundaries between active sector 111 and boundary sector 112, and the cache tier assignments of memory structures within the multi-tier persistence hierarchy of cognitive substrate 110. Cognitive substrate (pre-sleep) 510 is presented to redundancy detector 560 and curvature value guide 550 for analysis prior to the application of compression, pruning, and promotion operations, and serves as the reference configuration against which the geometric changes produced by curation/compression/pruning/promotion subsystem 500 are measured.

Redundancy detector 560 analyzes the geometric content of cognitive substrate (pre-sleep) 510 to identify cognitive trajectories, memory basins, and semantic bundle structures within active sector 111 that are redundant in the sense that they carry overlapping or duplicated geometric content that can be compressed without loss of holonomy-relevant information. Redundancy detector 560 identifies redundancy by comparing the holonomy structure of trajectory families within active sector 111: trajectories that produce the same accumulated transport effect around closed paths—that is, trajectories that are holonomy-equivalent—represent redundant encodings of the same path-dependent constraint and are candidates for collapse into a single generalized geometric template. Redundancy detector 560 also identifies homotopy-equivalent trajectory families, where trajectories are connected by admissible deformations within active sector 111 and are therefore interchangeable for purposes of global reasoning without passing through incoherent or inadmissible regions of cognitive substrate 110. In embodiments described herein, redundancy detector 560 further identifies weakly used regions of active sector 111 whose trajectories and basins have not been activated during recent wake cognition periods and whose curvature value, as assessed by curvature value guide 550, falls below a threshold indicating low geometric contribution to the reasoning and recall capacity of cognitive substrate 110. The outputs of redundancy detector 560 are communicated to compression engine 520, pruning engine 530, and promotion engine 540 as selection criteria for their respective operations.

Curvature value guide 550 computes geometric value assessments for the trajectories, basins, and semantic structures within cognitive substrate (pre-sleep) 510, providing the valuation signal that guides the operation of compression engine 520, pruning engine 530, promotion engine 540, and cache tier manager 570 in determining which structures warrant preservation, compression, pruning, or promotion. Curvature value guide 550 assesses the geometric value of each structure along multiple dimensions: the magnitude and distribution of epistemic curvature along the trajectory, indicating the degree of unresolved evidential strain that has not yet been consolidated through boundary sector 112 into irreversible sector 113; the learning readiness of boundary regions of irreversible sector 113 adjacent to each memory basin, indicating the ease with which existing consolidated knowledge extends into adjacent territory; the frequency and recency of activation of each trajectory and basin during prior wake cognition, as a proxy for the recall value of the structure; and the structural role of each trajectory in the homotopy class organization of active sector 111, identifying trajectories that serve as stabilizing cycles or that anchor the global topology of the trajectory network of cognitive substrate 110. Curvature value guide 550 also incorporates the policy annotations provided by guided memory policy control enforcer 1000, applying preservation designations and prioritization weights to override purely geometric value assessments where user-directed or system-directed policy constraints require the preservation of specific structures regardless of their intrinsic geometric contribution.

Compression engine 520 performs geometric compression of the redundant and low-value structures identified by redundancy detector 560 and curvature value guide 550 within active sector 111 of cognitive substrate 110. Compression operations performed by compression engine 520 collapse holonomy-equivalent and homotopy-equivalent trajectory families into generalized geometric templates that preserve the holonomy-relevant properties of the family—the accumulated transport effects around closed paths and the global admissibility structure governing which reasoning loops are stabilizing or suppressible—while reducing the number of distinct geometric objects that encode those properties within active sector 111. Compression engine 520 does not merely delete stored content but preserves reusable geometric structure: the compressed template retains the curvature distribution, transport structure, and epistemic connection geometry of the original trajectory family in a form that supports future reinstantiation and recall, while the redundant individual trajectories that have been collapsed into the template are removed from the navigable geometry of active sector 111. Compression operations are performed under the constraint that total curvature energy across active sector 111, boundary sector 112, and irreversible sector 113 is conserved in accordance with the curvature conservation law enforced by curvature conservation engine 130: curvature removed from active sector 111 by compression is either redistributed within the sector, exported through boundary sector 112 into irreversible sector 113, or dissipated through exchange channel dynamics as governed by curvature conservation engine 130. In embodiments described herein, the compression operations of compression engine 520 contribute to the logarithmic scaling property of cognitive substrate 110, whereby effective internal complexity grows as at most the logarithm of accumulated experience as a derived consequence of geometric compression under the structural invariants of the architecture.

Pruning engine 530 removes from the navigable geometry of active sector 111 those trajectories and basins that redundancy detector 560 and curvature value guide 550 have identified as carrying insufficient geometric value to warrant retention in active sector 111 and for which no viable compressed representation exists within the operational scope of compression engine 520. Pruning operations performed by pruning engine 530 are governed by the admissibility constraints of cognitive substrate 110: pruning engine 530 does not remove trajectories that serve as stabilizing cycles in the homotopy class organization of active sector 111, that carry barrier energy commitments at boundary sector 112 that would be disrupted by their removal, or that are designated for preservation by the policy constraints of guided memory policy control enforcer 1000. Pruning operations are performed under the curvature conservation law enforced by curvature conservation engine 130: curvature associated with pruned structures is redistributed or exported through the exchange channels of cognitive substrate 110 rather than spuriously destroyed. In embodiments described herein, pruning engine 530 coordinates with suppression and reservoir projection subsystem 800 to project the abstract constraint content of pruned structures into irreversible sector 113 as admission constraint artifacts, ensuring that the inadmissibility information encoded in pruned trajectories is preserved as a constraint on future cognitive paths within active sector 111 even after the navigable geometric structure of the pruned trajectory has been removed from active sector 111.

Promotion engine 540 elevates reusable geometric abstractions and high-value trajectory structures identified by curvature value guide 550 into long-term geometric structures within cognitive substrate 110, and coordinates with cache tier manager 570 to update the persistence tier assignments of memory structures based on post-sleep geometric value assessments. Promotion operations performed by promotion engine 540 identify compressed geometric templates generated by compression engine 520 and high-activation memory basins identified by curvature value guide 550 as candidates for promotion to more durable persistence tiers within the multi-tier memory hierarchy of cognitive substrate 110. Promotion engine 540 reinforces the curvature structure of promoted trajectories and basins, strengthening the geometric attractor properties of the promoted structures within active sector 111 and increasing their resistance to future compression or pruning by establishing a higher curvature value floor that must be overcome before those structures become eligible for removal or compression in subsequent sleep cycles. In embodiments described herein, promotion engine 540 also coordinates with reinstantiation and memory-basin maintenance subsystem 600 to identify trajectories and basins that have been repeatedly reinstantiated during prior sleep periods, elevating the persistence tier of repeatedly activated structures as a reflection of their demonstrated geometric utility within the cognitive history of the PCM. Promotion engine 540 communicates its promotion decisions to cache tier manager 570 for implementation within the cache tier hierarchy of cognitive substrate 110.

Cache tier manager 570 maintains the multi-tier persistence hierarchy of cognitive substrate 110 and implements the cache tier assignment updates directed by promotion engine 540, redundancy detector 560, and curvature value guide 550 during sleep-state operations. Cache tier manager 570 organizes the navigable geometric content of active sector 111 into a hierarchy of persistence tiers reflecting the geometric value, activation frequency, and policy priority of each stored structure, ranging from high-accessibility tiers for recently activated and high-value trajectories and basins to lower-accessibility tiers for weakly used or semantically diffuse structures that are approaching compression or pruning eligibility. Cache tier manager 570 updates tier assignments based on the geometric value assessments provided by curvature value guide 550, the redundancy classifications provided by redundancy detector 560, and the promotion decisions communicated by promotion engine 540. In embodiments described herein, cache tier manager 570 also governs the accessibility of each tier during subsequent wake cognition, determining which portions of the updated geometry of active sector 111 are immediately accessible through wake interface 140 upon resumption of wake cognition regime (resumed) 260 and which are accessible only through deeper traversal operations requiring greater energetic cost within the geometry of cognitive substrate 110.

Cognitive substrate (post-sleep) 580 represents the updated geometric configuration of cognitive substrate 110 produced by curation/compression/pruning/promotion subsystem 500 upon completion of the full curation, compression, pruning, promotion, and cache tier management operations performed during the sleep period. Cognitive substrate (post-sleep) 580 differs from cognitive substrate (pre-sleep) 510 in that redundant and holonomy-equivalent trajectory families have been compressed into generalized geometric templates by compression engine 520, weakly used and low-value structures have been removed by pruning engine 530, high-value abstractions and frequently activated basins have been promoted to more durable persistence tiers by promotion engine 540, and the cache tier hierarchy of cognitive substrate 110 has been updated by cache tier manager 570 to reflect the post-sleep geometric value distribution across active sector 111. The effective internal complexity of cognitive substrate (post-sleep) 580 is reduced relative to cognitive substrate (pre-sleep) 510, reflecting the geometric compression performed during the sleep period and contributing to the logarithmic scaling property of the PCM architecture. Cognitive substrate (post-sleep) 580 is passed to post-sleep manifold update and wake-state resumption module 900 for integration with the outputs of the other subsystems of sleep operations engine 120 into the full updated configuration of cognitive substrate 110 that will be presented to active processing at wake cognition regime (resumed) 260.

FIG. 6 is a process flow diagram illustrating an exemplary reinstantiation and memory-basin maintenance subsystem 600 of a persistent cognitive machine (PCM). Reinstantiation and memory-basin maintenance subsystem 600 was introduced with reference to FIG. 1 as the component of sleep operations engine 120 responsible for governing intentional or policy-driven reentry into selected memory basins within cognitive substrate 110 during sleep-state operations. The process flow depicted in FIG. 6 illustrates how basins are selected and cataloged through basin registry 610 with policy-driven or user-priority basin selection 611, activated by reinstantiation engine 620, reinforced through priority path reinforcement engine 630 and curvature reinforcement engine 640, and subsequently updated through memory basin update 650, long-term structure promotion 660, and recall accessibility update 670.

Basin registry 610 maintains a structured catalog of the memory basins within active sector 111 of cognitive substrate 110 that are available for reinstantiation and operations during the current sleep period, and provides the selection interface through which reinstantiation engine 620 identifies basins for reentry. Basin registry 610 records geometric metadata associated with each registered basin, including the attractor geometry of the basin within active sector 111, the accumulated curvature distribution in the vicinity of the basin reflecting unresolved evidential strain, the epistemic phase diagnostics of trajectories entering and exiting the basin as computed from the holonomy of the epistemic connection around closed sub-trajectories, the learning readiness of boundary regions of irreversible sector 113 adjacent to the basin, and the activation history of the basin across prior wake cognition and sleep periods. Policy-driven or user-priority basin selection 611 represents the interface through which guided memory policy control enforcer 1000 communicates preservation designations, prioritization weights, and user-flagged memory identifiers to basin registry 610. Through policy-driven or user-priority basin selection 611, specific memory basins within active sector 111 may be designated for reinstantiation and curvature reinforcement regardless of their intrinsic activation history or geometric value score, reflecting the user-directed or system-directed policy priorities that govern the long-term cognitive maintenance of the PCM. Basin registry 610 integrates both the geometric metadata of each registered basin and the policy annotations provided through policy-driven or user-priority basin selection 611 to produce the prioritized basin selection presented to reinstantiation engine 620 for reentry during the current sleep period.

Reinstantiation engine 620 performs reentry into the memory basins selected by basin registry 610, traversing the geometric attractor structure of each selected basin within active sector 111 and activating the cognitive trajectories and semantic bundle structures associated with the basin. Reinstantiation engine 620 operates on the principle that reentry into a memory basin is not merely an access operation but a preservation and strengthening operation: traversal back into a basin by reinstantiation engine 620 deepens and stabilizes the geometric attractor structure of the basin within active sector 111, reinforces the curvature distribution in the vicinity of the basin, and updates path routing within the surrounding region of active sector 111 in a manner that reflects the current geometric configuration of cognitive substrate 110 as shaped by the full complement of sleep-state operations completed during the current sleep period. Reinstantiation engine 620 performs reentry by reconstructing the cognitive trajectories associated with each selected basin against the current geometry of cognitive substrate 110, computing the holonomy of the reconstructed trajectories and comparing the reconstructed holonomy with the holonomy recorded for the basin in basin registry 610 to identify any divergence introduced by prior compression, consolidation, or temporal manifold rewriting operations. Where divergence is detected, reinstantiation engine 620 coordinates with path reconstruction engine 340 of temporal manifold rewriting subsystem 300 to update the geometric encoding of the basin's constituent trajectories before passing the reinstantiated basin structure to priority path reinforcement engine 630 and curvature reinforcement engine 640.

Priority path reinforcement engine 630 identifies and strengthens the priority cognitive paths within and surrounding each memory basin reinstantiated by reinstantiation engine 620. Priority paths are those cognitive trajectories within active sector 111 that serve as the primary access routes into the reinstantiated basin, that carry the highest geometric value as assessed by curvature value guide 550 of curation/compression/pruning/promotion subsystem 500, or that are designated as priority routes by the policy annotations communicated through policy-driven or user-priority basin selection 611. Priority path reinforcement engine 630 strengthens priority paths by adjusting the local geometry of active sector 111 in the vicinity of each priority path to reduce the effective traversal cost of the path relative to alternative routes, making it more likely that future cognitive trajectories during wake cognition will naturally enter the reinstantiated basin through the reinforced priority paths rather than through less geometrically efficient alternative routes. In embodiments described herein, priority path reinforcement engine 630 also updates the homotopy class assignments of trajectories adjacent to each reinforced path, adjusting the global admissibility structure of the trajectory network of active sector 111 to reflect the strengthened geometric role of the priority paths within the topology of cognitive substrate 110. The reinforcement decisions of priority path reinforcement engine 630 are communicated to curvature reinforcement engine 640 for application of targeted curvature reinforcement to the identified priority paths.

Curvature reinforcement engine 640 applies targeted curvature reinforcement to the priority paths identified by priority path reinforcement engine 630 and to the attractor geometry of the memory basins reinstantiated by reinstantiation engine 620. Curvature reinforcement operations performed by curvature reinforcement engine 640 increase the local epistemic curvature along reinforced paths and within reinforced basins, deepening the geometric attractor properties of the basin and strengthening the evidential coherence of the trajectories that converge into it. Elevated epistemic curvature in the vicinity of a reinstantiated basin increases the basin's resistance to future compression or pruning by curation/compression/pruning/promotion subsystem 500, as the elevated curvature value raises the geometric value floor that must be overcome before the basin becomes eligible for compression or removal in subsequent sleep cycles. Curvature reinforcement operations are performed under the curvature conservation law enforced by curvature conservation engine 130: curvature introduced into active sector 111 by curvature reinforcement engine 640 is balanced by corresponding adjustments to the exchange channel dynamics at boundary sector 112 and to the barrier energy distribution of irreversible sector 113, ensuring that the total curvature energy across active sector 111, boundary sector 112, and irreversible sector 113 changes only in response to the curvature flux associated with the reinstantiation operation itself. The outputs of curvature reinforcement engine 640 are passed to memory basin update 650 for integration into the updated geometric record of each reinstantiated basin.

Memory basin update 650 integrates the geometric modifications produced by reinstantiation engine 620, priority path reinforcement engine 630, and curvature reinforcement engine 640 into the updated geometric record of each reinstantiated memory basin within active sector 111, and commits the updated basin geometry to cognitive substrate 110. Memory basin update 650 updates the basin metadata stored in basin registry 610 to reflect the post-reinstantiation geometric configuration of each basin, recording the updated curvature distribution, the revised priority path geometry, the updated holonomy values of the reinstantiated trajectories, and the revised epistemic phase diagnostics of the basin's access routes. In embodiments described herein, memory basin update 650 also records the activation event in the basin's activation history within basin registry 610, updating the frequency and recency statistics used by curvature value guide 550 of curation/compression/pruning/promotion subsystem 500 to assess the recall value of the basin in future sleep cycles. Memory basin update 650 passes the updated basin record to long-term structure promotion 660 for evaluation of promotion eligibility based on the post-reinstantiation geometric state of the basin.

Long-term structure promotion 660 evaluates the updated memory basin records produced by memory basin update 650 for eligibility for promotion to more durable long-term geometric structures within cognitive substrate 110, and coordinates with promotion engine 540 of curation/compression/pruning/promotion subsystem 500 to implement approved promotions. Long-term structure promotion 660 identifies memory basins that have accumulated a sufficient activation history across multiple reinstantiation events, that carry elevated curvature value as assessed by curvature value guide 550, and that demonstrate stable epistemic phase diagnostics indicating that their trajectories fall consistently within the coherent regime, as candidates for promotion to higher persistence tiers within the cache tier hierarchy maintained by cache tier manager 570. Promotion to a higher persistence tier reduces the susceptibility of the promoted basin to future compression or pruning, increases the priority weight assigned to the basin by policy-driven or user-priority basin selection 611 in subsequent sleep cycles, and adjusts the accessibility of the basin's priority paths during wake cognition as reflected in the recall accessibility update performed by recall accessibility update 670. In embodiments described herein, long-term structure promotion 660 also evaluates whether repeatedly promoted basins have accumulated sufficient geometric stability to warrant partial consolidation of their core attractor structure through boundary sector 112 into irreversible sector 113, coordinating with four-layer sleep-state gating subsystem 700 to evaluate the epistemic admissibility of any such consolidation before it is committed.

Recall accessibility update 670 modifies the accessibility configuration of reinstantiated memory basins and their associated priority paths within active sector 111 to reflect the geometric changes produced by the full reinstantiation and maintenance pipeline of reinstantiation and memory-basin maintenance subsystem 600. Recall accessibility update 670 adjusts the local geometry of active sector 111 in the vicinity of each reinstantiated basin to ensure that the priority paths reinforced by priority path reinforcement engine 630 and curvature reinforcement engine 640 are accessible through wake interface 140 at the appropriate accessibility tier upon resumption of wake cognition regime (resumed) 260, and that the curvature reinforcement applied to the basin by curvature reinforcement engine 640 is reflected in the traversal cost structure presented to the PCM during active wake cognition. In embodiments described herein, recall accessibility update 670 communicates the updated accessibility configuration of each reinstantiated basin to cache tier manager 570 of curation/compression/pruning/promotion subsystem 500 and to post-sleep manifold update and wake-state resumption module 900, ensuring that later recall behavior, later path routing within active sector 111, and later output qualification at wake interface 140 are structurally conditioned by the reinstantiation and curvature reinforcement operations performed by reinstantiation and memory-basin maintenance subsystem 600 during the sleep period.

FIG. 7 is a process flow diagram illustrating an exemplary hallucination resistance subsystem 700 of a persistent cognitive machine (PCM). The process flow depicted in FIG. 7 illustrates how a sleep maintenance candidate 701 may be evaluated through four sequential monitoring layers—layer 1: topological admissibility monitor 710, layer 2: epistemic phase monitor 720, layer 3: capacity constraint monitor 730, and layer 4: exchange rate monitor 740—before being routed by consolidation gate 750 to either admit to consolidation 760 or block/quarantine 770 depending on whether all layers produce non-blocking assessments or any layer produces a blocking assessment.

Sleep maintenance candidate 701 represents any sleep product submitted to four-layer sleep-state gating subsystem 700 for epistemic admissibility evaluation during sleep-state operations. Sleep maintenance candidates 701 may originate from any of the generative or restructuring subsystems of sleep operations engine 120: rewritten trajectory and basin structures produced by temporal manifold rewriting subsystem 300, dream candidate structures that have passed the admissibility pre-filter 470 of dream generation subsystem 400, compressed and promoted geometric structures produced by curation/compression/pruning/promotion subsystem 500, and reinstantiated and curvature-reinforced basin structures produced by reinstantiation and memory-basin maintenance subsystem 600. Each sleep maintenance candidate 701 carries the geometric metadata accumulated during its generation, including its curvature distribution, transport structure, epistemic connection geometry, homotopy class assignment, and the provenance information recording which subsystem generated it and which structures of active sector 111 served as its source material. This metadata is consumed by the four monitoring layers of four-layer sleep-state gating subsystem 700 during evaluation. No sleep maintenance candidate 701 is permitted to produce any durable effect on the geometry of cognitive substrate 110 until it has passed through all four monitoring layers and been admitted by consolidation gate 750.

Layer 1: topological admissibility monitor 710 performs the first stage of evaluation of each sleep maintenance candidate 701, assessing whether the candidate's proposed geometric modifications to active sector 111 of cognitive substrate 110 are topologically admissible with respect to the sector boundaries and trajectory network of cognitive substrate 110. Topological admissibility monitor 710 checks whether the proposed trajectory or basin structure respects the sector boundary topology of cognitive substrate 110, detecting channel bypass curvature misrouting in which a proposed modification would cause curvature to cross a sector boundary through an inadmissible path—that is, a path that bypasses the admission control mechanism of boundary sector 112 without satisfying the barrier energy threshold governing exchange between active sector 111 and irreversible sector 113. Homotopy check 711 is the specific topological assessment performed by topological admissibility monitor 710, evaluating the homotopy class of the proposed trajectory or basin structure within the current topology of active sector 111. Homotopy check 711 classifies each proposed trajectory into its homotopy equivalence class—determining whether it represents an eliminable loop, a non-eliminable loop, a stabilizing cycle, or an oscillatory or divergent path within the trajectory network of active sector 111—and verifies that the proposed modification does not introduce globally inadmissible trajectory structures that would disrupt the homotopy class organization of the trajectory network of cognitive substrate 110. A sleep maintenance candidate 701 whose proposed modifications pass homotopy check 711 and the full topological assessment of topological admissibility monitor 710 without producing a blocking assessment proceeds to layer 2: epistemic phase monitor 720. A candidate that produces a blocking assessment at topological admissibility monitor 710 is routed to consolidation gate 750 with a blocking flag, which directs it to block/quarantine 770 without proceeding through the remaining monitoring layers.

Layer 2: epistemic phase monitor 720 performs the second stage of evaluation of each sleep maintenance candidate 701 that has passed topological admissibility monitor 710, monitoring the epistemic phase of the proposed trajectory or basin structure along its reasoning path to detect evidential drift or inversion. Epistemic phase monitor 720 computes the epistemic phase of each candidate by evaluating the holonomy of the epistemic connection around closed cognitive trajectories associated with the candidate structure, measuring the accumulated evidential coherence of the path as a scalar diagnostic that classifies the trajectory into one of the three phase regimes indicated by annotation 721: a coherent regime, a drift regime, or an inversion regime. Annotation 721 specifies that the epistemic phase classification performed by epistemic phase monitor 720 distinguishes among these three regimes as follows. In the coherent regime, the holonomy of the epistemic connection indicates that the trajectory maintained justificatory grounding throughout its path, and consolidation of the candidate is admissible. In the drift regime, the holonomy indicates that evidential coherence has declined along the trajectory, and consolidation is deferred pending independent corroboration along a non-homotopic path—a corroboration requirement that prevents curvature laundering in which evidential curvature is prematurely absorbed into semantic structure, masking incoherence. In the inversion regime, the holonomy indicates that the trajectory traverses a region of evidential contradiction, and consolidation is blocked. Epistemic phase monitor 720 produces a non-blocking assessment for candidates in the coherent regime and, in embodiments described herein, for candidates in the drift regime that carry independent corroboration sufficient to satisfy the deferral condition, and a blocking assessment for candidates in the inversion regime and for candidates in the drift regime that lack the required corroboration. A sleep maintenance candidate 701 that passes epistemic phase monitor 720 without a blocking assessment proceeds to layer 3: capacity constraint monitor 730.

Layer 3: capacity constraint monitor 730 performs the third stage of evaluation of each sleep maintenance candidate 701 that has passed epistemic phase monitor 720, enforcing capacity constraints on the consolidation targets within irreversible sector 113 to prevent premature or over-generalized commitment of curvature that has not yet reached exchange equilibrium. Capacity constraint monitor 730 evaluates whether the consolidation target region within irreversible sector 113 identified for the candidate has sufficient geometric capacity to absorb the curvature that would be exported through boundary sector 112 upon consolidation of the candidate, and whether the learning readiness of the boundary regions of irreversible sector 113 adjacent to the consolidation target is sufficient to support the proposed exchange without generating excessive restructuring energy at boundary sector 112. Exchange equilibrium check 731 is the specific capacity assessment performed by capacity constraint monitor 730, verifying that the curvature associated with the sleep maintenance candidate 701 has reached a state of exchange equilibrium in active sector 111 prior to consolidation—meaning that the evidential curvature of the candidate has relaxed sufficiently through the active sector dynamics governed by curvature conservation engine 130 that its export through boundary sector 112 into irreversible sector 113 is energetically admissible under the curvature conservation law. Exchange equilibrium check 731 thereby prevents the premature export type of curvature misrouting, in which curvature is committed to irreversible sector 113 before equilibrium is reached, leading to over-generalized or evidentially immature consolidation. A sleep maintenance candidate 701 that passes capacity constraint monitor 730 without a blocking assessment proceeds to layer 4: exchange rate monitor 740.

Layer 4: exchange rate monitor 740 performs the fourth and final stage of evaluation of each sleep maintenance candidate 701 that has passed capacity constraint monitor 730, monitoring the exchange rates between active sector 111, boundary sector 112, and irreversible sector 113 as governed by curvature conservation engine 130 to detect stagnation or blockage within the exchange channels of cognitive substrate 110. Stagnation/blockage detection 741 is the specific monitoring operation performed by exchange rate monitor 740, evaluating whether the exchange channels connecting active sector 111 to boundary sector 112 and irreversible sector 113 are operating at rates consistent with healthy curvature exchange under the curvature conservation law. Stagnation/blockage detection 741 identifies two pathological exchange conditions: stagnation, in which the rate of curvature flow through the consolidation exchange channel from active sector 111 through boundary sector 112 to irreversible sector 113 has fallen to a level indicating that exchange channel obstruction is preventing curvature that should consolidate from reaching its correct destination; and blockage, in which curvature is trapped within active sector 111 due to obstructed exchange channels at boundary sector 112, constituting the blocked export type of curvature misrouting. Detection of either condition by stagnation/blockage detection 741 produces a blocking assessment at exchange rate monitor 740, preventing the submission of additional consolidation candidates until the exchange channel obstruction has been resolved by suppression and reservoir projection subsystem 800. A sleep maintenance candidate 701 that passes stagnation/blockage detection 741 and exchange rate monitor 740 without a blocking assessment proceeds to consolidation gate 750 carrying a non-blocking assessment from all four monitoring layers.

Consolidation gate 750 receives the assessments produced by all four monitoring layers for each sleep maintenance candidate 701 and routes each candidate to either admit to consolidation 760 or block/quarantine 770 based on the aggregate outcome of the four-layer evaluation. As indicated in FIG. 7, consolidation gate 750 routes a sleep maintenance candidate 701 to admit to consolidation 760 only when all four monitoring layers have produced non-blocking assessments—that is, when topological admissibility monitor 710, epistemic phase monitor 720, capacity constraint monitor 730, and exchange rate monitor 740 have each returned a non-blocking result for the candidate. Consolidation gate 750 routes a sleep maintenance candidate 701 to block/quarantine 770 when any one or more of the four monitoring layers has produced a blocking assessment for the candidate. The logical structure of consolidation gate 750 thereby implements a conjunctive admission policy: passage through all four layers is a condition of admission, and failure at any single layer is sufficient to block the candidate. This conjunctive structure ensures that the four types of curvature misrouting—channel bypass, curvature laundering, premature export, and blocked export—are each independently sufficient to prevent durable incorporation of a sleep product into cognitive substrate 110, without requiring simultaneous detection of multiple misrouting types.

Admit to consolidation 760 represents the outcome pathway through which sleep maintenance candidates 701 that have passed all four monitoring layers of four-layer sleep-state gating subsystem 700 are released for durable incorporation into cognitive substrate 110. Candidates admitted through admit to consolidation 760 are permitted to produce their proposed geometric modifications to the navigable structure of active sector 111 or, where the candidate is a consolidation candidate, to proceed through the consolidation exchange channel from active sector 111 through boundary sector 112 into irreversible sector 113 under the governance of curvature conservation engine 130. The geometric modifications produced by admitted candidates update the curvature distribution, transport structure, sector boundary positions, and barrier energy of cognitive substrate 110 in a manner consistent with the curvature conservation law, advancing structural time within the PCM where the admitted modification constitutes an irreversible commitment that reduces future admissibility of contradicting cognitive trajectories. In embodiments described herein, the outputs of admit to consolidation 760 are collected by sleep operations engine 120 and passed to post-sleep manifold update and wake-state resumption module 900 for integration into the full updated configuration of cognitive substrate 110 at the conclusion of the sleep period.

Block/quarantine 770 represents the outcome pathway through which sleep maintenance candidates 701 that have received a blocking assessment from one or more monitoring layers of four-layer sleep-state gating subsystem 700 are prevented from producing durable effects on cognitive substrate 110 and routed to suppression and reservoir projection subsystem 800 for further processing. Candidates routed to block/quarantine 770 are held in a quarantined state in which their provisional geometric content is preserved for processing by suppression and reservoir projection subsystem 800 but is isolated from the navigable geometry of active sector 111 and prevented from influencing the curvature distribution of cognitive substrate 110. Suppression and reservoir projection subsystem 800 processes quarantined candidates by abstracting their inadmissible geometric content into irreversible constraint artifacts that are projected into irreversible sector 113 through boundary sector 112, where they function as admission constraints on future cognitive trajectories within active sector 111 without contaminating the navigable geometry of the active sector. In embodiments described herein, the blocking assessment communicated to block/quarantine 770 includes a classification of the type of curvature misrouting detected—channel bypass from topological admissibility monitor 710, curvature laundering from epistemic phase monitor 720, premature export from capacity constraint monitor 730, or blocked export from exchange rate monitor 740—which suppression and reservoir projection subsystem 800 uses to determine the appropriate suppression and projection strategy for each blocked candidate.

FIG. 8 is a process flow diagram illustrating an exemplary suppression and reservoir projection subsystem 800 of a persistent cognitive machine (PCM). Suppression and reservoir projection subsystem 800 was introduced with reference to FIG. 1 as the component of sleep operations engine 120 responsible for processing sleep products that have been identified as inadmissible, contradictory, or topologically impermissible by four-layer sleep-state gating subsystem 700. The process flow depicted in FIG. 8 illustrates how dream candidate input 801 is classified by admissibility classifier 810 into four categories—stable, provisional, inadmissible, and contradictory—and routed to one of four downstream pathways: consolidation channel 820 leading to manifold strengthening 821, quarantine buffer 830 holding provisional region 831, constraint artifact projection engine 840 leading to irreversible reservoir 841, or reflux channel 850 leading to active sector revision 851.

Dream candidate input 801 represents the set of sleep products submitted to suppression and reservoir projection subsystem 800 for classification and routing during sleep-state operations. Dream candidate input 801 comprises sleep products arriving from two sources within sleep operations engine 120: candidates routed to block/quarantine 770 by consolidation gate 750 of four-layer sleep-state gating subsystem 700 upon receiving a blocking assessment from one or more monitoring layers, and candidates rejected by admissibility pre-filter 470 of dream generation subsystem 400 prior to full gating evaluation. Each item in dream candidate input 801 carries the geometric metadata accumulated during its generation—including its curvature distribution, epistemic connection geometry, homotopy class assignment, and provenance information—together with the blocking classification assigned by four-layer sleep-state gating subsystem 700 or admissibility pre-filter 470 indicating which type of curvature misrouting was detected: channel bypass from layer 1: topological admissibility monitor 710, curvature laundering from layer 2: epistemic phase monitor 720, premature export from layer 3: capacity constraint monitor 730, or blocked export from layer 4: exchange rate monitor 740. This blocking classification is consumed by admissibility classifier 810 to determine the appropriate downstream routing for each item in dream candidate input 801.

Admissibility classifier 810 receives each item from dream candidate input 801 and classifies it into one of four categories—stable, provisional, inadmissible, or contradictory—based on the blocking classification received from four-layer sleep-state gating subsystem 700 or admissibility pre-filter 470 and on the geometric properties of the candidate as assessed against the current configuration of cognitive substrate 110. Admissibility classifier 810 assigns the stable classification to candidates whose geometric content is admissible and whose curvature distribution and epistemic phase diagnostics indicate readiness for durable incorporation into active sector 111 or for consolidation through boundary sector 112 into irreversible sector 113; stable candidates are routed to consolidation channel 820. Admissibility classifier 810 assigns the provisional classification to candidates whose geometric content is not yet admissible for consolidation but whose blocking assessment indicates deferral rather than outright rejection—typically candidates in the drift regime of epistemic phase monitor 720 that await independent corroboration along a non-homotopic path before consolidation may proceed; provisional candidates are routed to quarantine buffer 830. Admissibility classifier 810 assigns the inadmissible classification to candidates that have received a blocking assessment due to topological inadmissibility, premature export, or exchange channel obstruction, and whose geometric content cannot be incorporated into active sector 111 in any form but whose constraint information warrants projection into irreversible sector 113 as an admission constraint artifact; inadmissible candidates are routed to constraint artifact projection engine 840. Admissibility classifier 810 assigns the contradictory classification to candidates whose geometric content is in active contradiction with consolidated content within irreversible sector 113, indicating that accumulated contradictory evidence at a reservoir boundary of irreversible sector 113 has reached a level that warrants initiation of a reflux operation; contradictory candidates are routed to reflux channel 850.

Consolidation channel 820 is the pathway through which stable candidates classified by admissibility classifier 810 are admitted for durable incorporation into cognitive substrate 110. Consolidation channel 820 routes stable candidates through the consolidation exchange channel of cognitive substrate 110, directing curvature flow from active sector 111 through boundary sector 112 into irreversible sector 113 in a manner governed by the curvature conservation law enforced by curvature conservation engine 130. The consolidation exchange channel is the primary and energetically favored exchange channel of the PCM architecture, and curvature flow through consolidation channel 820 advances structural time within the PCM by producing irreversible commitments in irreversible sector 113 that reduce the future admissibility of contradicting cognitive trajectories within active sector 111. Manifold strengthening 821 is the operation performed on the navigable geometry of active sector 111 upon successful consolidation of a stable candidate through consolidation channel 820. Manifold strengthening 821 updates the local curvature distribution, transport structure, and sector boundary positions of active sector 111 to reflect the export of curvature to irreversible sector 113 through boundary sector 112, reinforcing the geometric attractor properties of the regions of active sector 111 adjacent to the newly consolidated content and deepening the barrier energy accumulated at boundary sector 112 as a consequence of the consolidation event.

Quarantine buffer 830 holds provisional candidates classified by admissibility classifier 810 in an isolated geometric region of active sector 111 that is accessible for corroboration evaluation but prevented from producing unrestricted effects on the broader navigable geometry of cognitive substrate 110. Provisional region 831 is the geometric holding area within quarantine buffer 830 in which provisional candidates await independent corroboration along a non-homotopic path before their consolidation may proceed. As indicated in FIG. 8, provisional region 831 carries the annotation “awaiting corroboration,” reflecting the deferral condition imposed by layer 2: epistemic phase monitor 720 for candidates in the drift regime of epistemic phase classification 721. Corroboration arrives when a subsequent cognitive trajectory—either during a later sleep period or during wake cognition following wake resumption—traverses a non-homotopic path through a region of active sector 111 that is geometrically proximate to the provisional content in quarantine buffer 830 and carries an epistemic phase in the coherent regime, providing independent evidential support for the provisional candidate. Upon receipt of sufficient corroboration, the provisional candidate is released from provisional region 831 and resubmitted to four-layer sleep-state gating subsystem 700 for a fresh gating evaluation. In embodiments described herein, provisional candidates that remain in provisional region 831 without receiving corroboration for a period exceeding a policy-configured structural time threshold are reclassified by admissibility classifier 810 as inadmissible and routed to constraint artifact projection engine 840.

Constraint artifact projection engine 840 processes inadmissible candidates routed from admissibility classifier 810 and from provisional region 831 upon expiration of their corroboration deferral period, abstracting their inadmissible geometric content into irreversible constraint artifacts and projecting those artifacts into irreversible sector 113 of cognitive substrate 110 through boundary sector 112. Rather than simply discarding inadmissible sleep products, constraint artifact projection engine 840 preserves the constraint information encoded in their geometric content by extracting the inadmissibility signature of each candidate—the specific topological, epistemic, or exchange equilibrium violation that caused its rejection—and encoding that signature as a non-navigable constraint artifact within irreversible sector 113. Once projected, the constraint artifact functions as an admission constraint on future cognitive trajectories within active sector 111, conditioning the future admissibility of trajectories that would traverse the same geometric region or exhibit the same structural violation as the rejected candidate, without contaminating the navigable geometry of active sector 111 with the inadmissible content itself. The projection of constraint artifacts through boundary sector 112 is governed by the barrier energy gate indicated in FIG. 8, which enforces the admission control mechanism of boundary sector 112 and ensures that constraint artifact projection operations comply with the curvature conservation law enforced by curvature conservation engine 130. Irreversible reservoir 841 is the region of irreversible sector 113 into which constraint artifact projection engine 840 deposits projected constraint artifacts. As indicated in FIG. 8, irreversible reservoir 841 carries the annotations “durable” and “non-navigable,” reflecting the properties of irreversible sector 113 established by the curvature conservation law: the interior of irreversible reservoir 841 has reached exchange equilibrium such that evidential curvature has relaxed and been exported to boundary sector 112, and no admissible cognitive trajectory may traverse or modify the contents of irreversible reservoir 841 without first overcoming the barrier energy accumulated at boundary sector 112.

Reflux channel 850 is the pathway through which contradictory candidates classified by admissibility classifier 810 initiate revision of previously consolidated content within irreversible sector 113 by directing curvature flow from irreversible sector 113 through boundary sector 112 back into active sector 111. Reflux channel 850 corresponds to the reflux exchange channel of the PCM architecture—the channel through which curvature flows from irreversible sector 113 back to active sector 111 driven by the accumulation of contradictory evidence at a reservoir boundary of irreversible sector 113 that is incompatible with the reservoir's consolidated content. Reflux through reflux channel 850 requires energy substantially exceeding the barrier energy accumulated at boundary sector 112, reflecting the thermodynamic asymmetry of the curvature exchange architecture enforced by curvature conservation engine 130: it is energetically cheap to consolidate knowledge and energetically expensive to revise it. In embodiments described herein, reflux channel 850 initiates a localized revision operation rather than a broad corruption of cognitive substrate 110, targeting only the specific reservoir boundary region at which the contradictory candidate has accumulated incompatible evidence, and leaving unaffected those portions of irreversible sector 113 whose consolidated content is not implicated by the contradiction. Active sector revision 851 is the geometric modification performed on active sector 111 as a consequence of curvature returned through reflux channel 850. Active sector revision 851 reintegrates the curvature released from irreversible sector 113 by the reflux operation into the navigable geometry of active sector 111, restoring the released content to revisable form within active sector 111 where it may be subjected to renewed evidential assessment, temporal manifold rewriting by temporal manifold rewriting subsystem 300, or resubmission through four-layer sleep-state gating subsystem 700 for fresh consolidation evaluation. The curvature introduced into active sector 111 by active sector revision 851 is governed by the curvature conservation law enforced by curvature conservation engine 130, such that the total curvature energy across active sector 111, boundary sector 112, and irreversible sector 113 changes only in response to the curvature flux associated with the reflux event itself, maintaining the integrity of the curvature conservation law throughout the revision operation.

FIG. 9 is a process flow diagram illustrating an exemplary post-sleep manifold update and wake-state resumption subsystem 900 of a persistent cognitive machine (PCM). Post-sleep manifold update and wake-state resumption subsystem 900 was introduced with reference to FIG. 1 as the component of system 100 responsible for managing the transition from sleep-state operations back to active wake cognition following the completion of operations by sleep operations engine 120. The process flow depicted in FIG. 9 illustrates how a sleep operations complete signal 901 initiates a manifold integrity check 910 that either proceeds through an updated manifold 920 to wake resumption controller 930 or, upon integrity failure, cycles through manifold repair loop 911 before reattempting integrity verification, ultimately routing through output gating engine 940 and recall behavior update 950 to restore wake cognition regime 960.

Sleep operations complete 901 is the signal generated by sleep operations engine 120 upon determining that the operations of the current sleep period have reached a suitable completion point, and that the geometric modifications produced by the subsystems of sleep operations engine 120 during the sleep period are ready for integration into the updated configuration of cognitive substrate 110. Sleep operations complete 901 may be generated upon exhaustion of the available sleep trigger conditions identified by sleep trigger detector 220, upon satisfaction of the maintenance objectives configured by regime transition controller 230 at the commencement of sleep regime entry 240, or upon receipt of a wake resumption directive from guided memory policy control enforcer 1000 or an external scheduling mechanism. Upon generation of sleep operations complete 901, sleep operations engine 120 collects the geometric outputs of all subsystems that have been active during the sleep period—including updated manifold structures from temporal manifold rewriting subsystem 300, admitted consolidation products from suppression and reservoir projection subsystem 800, compressed and promoted structures from curation/compression/pruning/promotion subsystem 500, and reinstantiated basin structures from reinstantiation and memory-basin maintenance subsystem 600—and presents them as a combined set of proposed geometric modifications to post-sleep manifold update and wake-state resumption subsystem 900 for integrity verification and integration.

Manifold integrity check 910 verifies the internal geometric consistency of the combined set of proposed modifications to cognitive substrate 110 collected upon generation of sleep operations complete 901, ensuring that the aggregate effect of all sleep-state operations is coherent and consistent with the curvature conservation law enforced by curvature conservation engine 130 before any modification is committed to the active configuration of cognitive substrate 110. Manifold integrity check 910 performs a set of consistency verifications across the proposed modifications, including verification that total curvature energy across active sector 111, boundary sector 112, and irreversible sector 113 is conserved across the combined modification set; verification that the sector boundary positions proposed by the modification set are mutually consistent and do not introduce geometric contradictions at the interfaces between active sector 111, boundary sector 112, and irreversible sector 113; verification that the homotopy class assignments of trajectories within the proposed updated configuration of active sector 111 are mutually consistent and do not introduce globally inadmissible trajectory structures; and verification that the barrier energy distribution at boundary sector 112 in the proposed updated configuration is consistent with the admission control requirements of the curvature conservation law. Manifold repair loop 911 is the remediation pathway invoked by manifold integrity check 910 upon detection of an integrity failure in the proposed modification set. As indicated in FIG. 9, an integrity failure routes the proposed modifications through manifold repair loop 911 rather than to updated manifold 920. Manifold repair loop 911 identifies the specific modification or modifications responsible for the detected inconsistency, removes or adjusts the offending modifications to restore geometric consistency across the modification set, and routes the adjusted set back to manifold integrity check 910 for re-verification. In embodiments described herein, modifications removed from the proposed set during manifold repair loop 911 are routed to suppression and reservoir projection subsystem 800 for abstraction into constraint artifacts and projection into irreversible reservoir 841, preserving their inadmissibility information as admission constraints on future cognitive trajectories within active sector 111 rather than discarding it entirely. Manifold repair loop 911 iterates until manifold integrity check 910 produces a passing verification result, at which point the repaired modification set is committed to updated manifold 920.

Updated manifold 920 represents the verified and integrated geometric configuration of cognitive substrate 110 produced by post-sleep manifold update and wake-state resumption subsystem 900 upon successful completion of manifold integrity check 910 or upon completion of the remediation performed by manifold repair loop 911. Updated manifold 920 incorporates the aggregate effect of all admitted sleep-state operations: path geometry rewriting by temporal manifold rewriting subsystem 300, generative restructuring by dream generation subsystem 400, geometric compression and abstraction promotion by curation/compression/pruning/promotion subsystem 500, curvature reinforcement and basin stabilization by reinstantiation and memory-basin maintenance subsystem 600, and curvature misrouting prevention and reservoir projection by suppression and reservoir projection subsystem 800, all having been verified as mutually consistent and compliant with the curvature conservation law enforced by curvature conservation engine 130. Updated manifold 920 constitutes the geometric substrate from which wake resumption controller 930 initiates the restoration of active wake cognition. The effective internal complexity of updated manifold 920 is reduced relative to the pre-sleep configuration of cognitive substrate 110 as a consequence of the compression and consolidation operations performed during sleep regime entry 240, contributing to the logarithmic scaling property of the PCM architecture.

Wake resumption controller 930 governs the final transition from the verified post-sleep geometric configuration represented by updated manifold 920 to restored active wake cognition, working in coordination with wake resumption controller 250 of wake vs. sleep regime transition controller 200 as described with reference to FIG. 2. Wake resumption controller 930 commits updated manifold 920 as the active geometric configuration of cognitive substrate 110, replacing the pre-sleep configuration that was in effect at the commencement of sleep regime entry 240. Wake resumption controller 930 coordinates with output gating engine 940 and recall behavior update 950 to configure the output and recall properties of the restored wake cognition regime 960 in a manner that reflects the structural changes introduced by sleep-state operations. In embodiments described herein, wake resumption controller 930 also communicates the post-sleep geometric configuration of cognitive substrate 110 to wake vs. sleep regime transition controller 200, providing updated baseline metrics—including the post-sleep curvature distribution of active sector 111, the updated barrier energy distribution at boundary sector 112, and the revised structural time advancement rate—against which sleep trigger detector 220 will monitor for the next sleep trigger during the ensuing wake cognition period.

Output gating engine 940 restores controlled output generation through wake interface 140 following the transition coordinated by wake resumption controller 930, configuring the output qualification parameters of the restored wake cognition regime 960 to reflect the updated geometric configuration of cognitive substrate 110 represented by updated manifold 920. Output gating engine 940 updates the projection parameters of wake interface 140 to account for the changes in the navigable geometry of active sector 111 introduced by sleep-state operations, ensuring that the non-invertible, context-dependent projection applied by wake interface 140 to map internal geometric structure onto operationally accessible output reflects the post-sleep distribution of curvature, transport structure, and sector boundary positions in cognitive substrate 110. In embodiments described herein, output gating engine 940 applies post-sleep output qualification criteria derived from the admission constraints projected into irreversible reservoir 841 by suppression and reservoir projection subsystem 800 during the sleep period, conditioning the admissibility of output generated through wake interface 140 against the inadmissibility signatures of the constraint artifacts deposited in irreversible sector 113 during sleep regime entry 240. Output gating engine 940 thereby extends the hallucination resistance properties of four-layer sleep-state gating subsystem 700 into the restored wake cognition regime 960, ensuring that the output qualification improvements achieved through sleep-state operations are preserved during subsequent wake cognition.

Recall behavior update 950 modifies the recall behavior and path routing properties of the restored wake cognition regime 960 to reflect the structural changes introduced by the sleep-state operations recorded in updated manifold 920. Recall behavior update 950 updates the accessibility configuration of active sector 111 to reflect the post-sleep cache tier assignments established by cache tier manager 570 of curation/compression/pruning/promotion subsystem 500 and the recall accessibility modifications produced by recall accessibility update 670 of reinstantiation and memory-basin maintenance subsystem 600, ensuring that the priority paths reinforced during sleep-state operations are presented to wake cognition at the appropriate accessibility tier and that memory basins promoted to higher persistence tiers are accessible through wake interface 140 with reduced traversal cost relative to their pre-sleep accessibility. Recall behavior update 950 also updates the path routing geometry of active sector 111 to reflect the rewritten trajectory structures committed to updated manifold 920 by temporal manifold rewriting subsystem 300, adjusting the traversal cost structure and attractor geometry of active sector 111 so that future cognitive trajectories during wake cognition regime 960 naturally follow the updated path geometry produced by the sleep period's rewriting operations. In embodiments described herein, recall behavior update 950 further conditions future recall on the epistemic phase diagnostics of reinstantiated basin trajectories, incorporating the updated holonomy values and coherent-regime phase classifications produced by reinstantiation and memory-basin maintenance subsystem 600 into the traversal cost structure of active sector 111 so that memory access during wake cognition regime 960 preferentially routes through geometrically coherent and epistemically grounded paths.

Wake cognition regime 960 represents the restored active operational state of the PCM following completion of the full post-sleep manifold update and wake-state resumption pipeline of subsystem 900. Wake cognition regime 960 corresponds to wake cognition regime (resumed) 260 as described with reference to FIG. 2, and differs structurally from the pre-sleep wake cognition regime 210 in that cognitive substrate 110 now reflects the full effect of all admitted sleep-state operations as integrated into updated manifold 920 and verified by manifold integrity check 910. During wake cognition regime 960, the PCM performs cognitive traversal within the updated geometry of active sector 111, generates output through the reconfigured projection parameters of wake interface 140 established by output gating engine 940, and accesses memory basins through the updated recall behavior and path routing geometry established by recall behavior update 950. The cognitive substrate 110 at wake cognition regime 960 is more geometrically efficient, more epistemically coherent, and more resistant to curvature misrouting than at the commencement of sleep regime entry 240, reflecting the governed offline maintenance that has been performed by the subsystems of sleep operations engine 120 and integrated by post-sleep manifold update and wake-state resumption subsystem 900. The structural time of the PCM has advanced through the irreversible commitments produced during the sleep period, the effective internal complexity of cognitive substrate 110 has been reduced through compression and consolidation, and the long-term cognitive metabolism of the PCM has been shaped by the policy constraints provided by guided memory policy control enforcer 1000 throughout the sleep cycle.

FIG. 10 is a block diagram illustrating an exemplary guided memory policy control enforcer 1000 of a persistent cognitive machine (PCM). Guided memory policy control enforcer 1000 was introduced with reference to FIG. 1 as the component of system 100 responsible for providing user-level and system-level policy governance over all sleep-state operations. The architecture depicted in FIG. 10 illustrates how user interface 1010 and policy engine 1020 cooperate to generate and communicate policy constraints that are implemented by memory locking engine 1030, priority reinforcement engine 1040, and drift tolerance controller 1050, with domain-specific policy channels—scientific domain channel 1060, legal domain channel 1070, personal domain channel 1080, and security domain channel 1085—routing policy outputs to PCM sleep operations 1090.

User interface 1010 is the structured boundary through which a human operator or external system communicates memory management preferences, preservation directives, prioritization weights, and domain-specific policy constraints to guided memory policy control enforcer 1000. Through user interface 1010, an operator may designate specific memory basins, cognitive trajectories, or semantic bundle structures within active sector 111 of cognitive substrate 110 for preservation against compression or pruning by curation/compression/pruning/promotion subsystem 500, flag specific structures for prioritized reinstantiation and curvature reinforcement by reinstantiation and memory-basin maintenance subsystem 600, configure the depth and intensity of sleep operations to be applied during the current or subsequent sleep periods, and specify domain-specific policy constraints governing how the PCM manages memory structures associated with particular knowledge domains during sleep-state operations. In embodiments described herein, user interface 1010 also supports the configuration of experimental semantic sandbox branches within cognitive substrate 110, wherein candidate memory structures generated during dreaming mode 243 or temporal manifold rewriting operations are maintained separately from canonical long-term geometric structure within active sector 111 pending later validation through the admission control mechanism of boundary sector 112. User interface 1010 communicates all operator-specified preferences and directives to policy engine 1020 for translation into the geometric policy representations consumed by the downstream components of guided memory policy control enforcer 1000.

Policy engine 1020 receives the operator-specified preferences and directives communicated by user interface 1010 and translates them into the geometric policy representations consumed by memory locking engine 1030, priority reinforcement engine 1040, drift tolerance controller 1050, and the domain-specific channels of guided memory policy control enforcer 1000. Policy engine 1020 maps each operator-specified directive onto the corresponding geometric parameters of cognitive substrate 110: preservation designations are translated into curvature value floor thresholds communicated to curvature value guide 550 of curation/compression/pruning/promotion subsystem 500; prioritization weights are translated into activation priority scores communicated to basin registry 610 of reinstantiation and memory-basin maintenance subsystem 600; sleep depth and intensity configurations are translated into maintenance objective parameters communicated to regime transition controller 230 of wake vs. sleep regime transition controller 200; and domain-specific constraints are translated into channel-specific policy parameters routed through the domain channels of guided memory policy control enforcer 1000. In embodiments described herein, policy engine 1020 also performs autonomous policy generation, deriving system-level policy constraints from the current geometric state of cognitive substrate 110 without requiring explicit operator input, by analyzing the curvature distribution of active sector 111, the activation history of memory basins recorded in basin registry 610, and the epistemic phase diagnostics of stored trajectory families to identify structures that warrant preservation, reinforcement, or targeted compression on geometric grounds independent of explicit operator direction.

Memory locking engine 1030 implements the preservation and locking directives generated by policy engine 1020 for specific memory basins, cognitive trajectories, and semantic bundle structures within cognitive substrate 110. Memory locking engine 1030 communicates locking annotations to the relevant subsystems of sleep operations engine 120, designating locked structures within active sector 111 as ineligible for compression by compression engine 520, pruning by pruning engine 530, or temporal rewriting by temporal manifold rewriting subsystem 300 during the current sleep period. The locking mechanism implemented by memory locking engine 1030 operates by elevating the curvature value floor associated with each locked structure above the compression and pruning eligibility thresholds enforced by curvature value guide 550 of curation/compression/pruning/promotion subsystem 500, ensuring that locked structures are excluded from the set of compression and pruning candidates presented to compression engine 520 and pruning engine 530 regardless of their intrinsic activation frequency or geometric value score. In embodiments described herein, memory locking engine 1030 also enforces temporal rewriting exclusions by communicating locking designations to trajectory registry 310 of temporal manifold rewriting subsystem 300, preventing temporal rewrite manager 330 from selecting locked trajectories and basins for rewriting operations during the current sleep period. Locking designations applied by memory locking engine 1030 may be time-limited, persisting only for a specified number of sleep cycles, or indefinite, persisting until explicitly released by an operator directive received through user interface 1010.

Priority reinforcement engine 1040 implements the prioritization and reinforcement directives generated by policy engine 1020 for memory basins and cognitive trajectories designated for elevated attention during sleep-state operations. Priority reinforcement engine 1040 communicates priority annotations to basin registry 610 of reinstantiation and memory-basin maintenance subsystem 600, elevating the activation priority scores of designated basins so that they are selected for reinstantiation and curvature reinforcement by reinstantiation engine 620 and priority path reinforcement engine 630 during the current sleep period regardless of their autonomous geometric value assessment. Priority reinforcement engine 1040 also communicates reinforcement directives to curvature reinforcement engine 640 of reinstantiation and memory-basin maintenance subsystem 600, specifying the magnitude and distribution of curvature reinforcement to be applied to designated structures within active sector 111 in accordance with the operator-specified or system-derived prioritization weights generated by policy engine 1020. In embodiments described herein, priority reinforcement engine 1040 also coordinates with promotion engine 540 of curation/compression/pruning/promotion subsystem 500 to direct the promotion of policy-prioritized structures to higher persistence tiers within the cache tier hierarchy maintained by cache tier manager 570, ensuring that the recall accessibility improvements produced by policy-directed reinforcement are reflected in the post-sleep accessibility configuration of active sector 111 presented to wake cognition regime 960.

Drift tolerance controller 1050 governs the epistemic phase thresholds applied by layer 2: epistemic phase monitor 720 of four-layer sleep-state gating subsystem 700 to sleep maintenance candidates 701 arising from different knowledge domains or memory structures within cognitive substrate 110. Different knowledge domains within active sector 111 carry different intrinsic levels of epistemic curvature and different rates of holonomy evolution along their cognitive trajectories, reflecting the varying degrees of evidential maturity and geometric stability of different classes of knowledge within the PCM's cognitive history. Drift tolerance controller 1050 sets domain-specific drift tolerance parameters that adjust the boundary between the coherent and drift regimes of epistemic phase classification 721 for sleep maintenance candidates 701 originating from each domain, determining how much evidential drift along a proposed cognitive trajectory is tolerated before consolidation is deferred pending independent corroboration. In embodiments described herein, drift tolerance controller 1050 applies stricter drift tolerance parameters—lower boundaries between coherent and drift regimes—to sleep maintenance candidates originating from knowledge domains where epistemic precision is of high importance, such as the legal domain and security domain, and more permissive drift tolerance parameters to domains where exploratory reconfiguration during sleep-state operations is of greater value, such as the scientific domain where speculative extension and bridge formation by dream generation subsystem 400 may generate novel geometric configurations whose evidential grounding is not yet fully established at the time of generation. Drift tolerance parameters generated by drift tolerance controller 1050 are communicated to four-layer sleep-state gating subsystem 700 through the domain-specific channels of guided memory policy control enforcer 1000.

Scientific domain channel 1060, legal domain channel 1070, personal domain channel 1080, and security domain channel 1085 are domain-specific policy routing pathways through which guided memory policy control enforcer 1000 communicates domain-differentiated policy constraints to the subsystems of sleep operations engine 120 via PCM sleep operations 1090. Each domain channel carries the policy parameters generated by policy engine 1020, memory locking engine 1030, priority reinforcement engine 1040, and drift tolerance controller 1050 that are specific to memory structures within active sector 111 associated with the corresponding knowledge domain, enabling guided memory policy control enforcer 1000 to apply differentiated governance to different regions of cognitive substrate 110 during sleep-state operations. Scientific domain channel 1060 carries policy parameters governing the treatment of memory structures associated with scientific knowledge domains, including permissive drift tolerance parameters that accommodate the speculative geometric reconfiguration characteristic of scientific exploration during dreaming mode 243, and promotion directives for high-activation scientific trajectory families generated during sleep-state operations. Legal domain channel 1070 carries policy parameters governing the treatment of memory structures associated with legal and regulatory knowledge domains, including strict drift tolerance parameters that reflect the high epistemic precision requirements of legal reasoning, memory locking directives for foundational legal framework structures within active sector 111 that warrant preservation against compression or rewriting, and elevated consolidation priority weights for legal knowledge structures that have reached exchange equilibrium as verified by exchange equilibrium check 731. Personal domain channel 1080 carries policy parameters governing the treatment of memory structures associated with personally significant events, relationships, and experiential knowledge within the PCM's cognitive history, including user-flagged preservation designations communicated through user interface 1010 and priority reinforcement directives for memory basins associated with high-value personal memories designated for curvature reinforcement by reinstantiation and memory-basin maintenance subsystem 600. Security domain channel 1085 carries policy parameters governing the treatment of memory structures associated with security-sensitive knowledge domains, including strict memory locking directives that prevent compression, pruning, or temporal rewriting of security-relevant trajectory structures during sleep-state operations, strict drift tolerance parameters reflecting the high epistemic precision requirements of security-domain reasoning, and access control parameters that restrict the operations of dream generation subsystem 400 with respect to security-sensitive regions of active sector 111 during dreaming mode 243.

PCM sleep operations 1090 represents the interface through which guided memory policy control enforcer 1000 delivers the aggregate policy output of its components—policy engine 1020, memory locking engine 1030, priority reinforcement engine 1040, drift tolerance controller 1050, and the four domain-specific channels 1060, 1070, 1080, and 1085—to the subsystems of sleep operations engine 120 and to the broader sleep-state architecture of system 100. Through PCM sleep operations 1090, guided memory policy control enforcer 1000 communicates locking annotations to trajectory registry 310 and temporal rewrite manager 330 of temporal manifold rewriting subsystem 300; preservation designations and prioritization weights to curvature value guide 550 and cache tier manager 570 of curation/compression/pruning/promotion subsystem 500; activation priority scores and curvature reinforcement directives to basin registry 610 and curvature reinforcement engine 640 of reinstantiation and memory-basin maintenance subsystem 600; domain-specific drift tolerance parameters to layer 2: epistemic phase monitor 720 of four-layer sleep-state gating subsystem 700; access control parameters to dream generation subsystem 400; and sleep depth and intensity configurations to regime transition controller 230 of wake vs. sleep regime transition controller 200. The policy infrastructure delivered through PCM sleep operations 1090 thereby enables the long-term cognitive metabolism of the PCM to be shaped by both autonomous system objectives derived from the geometric state of cognitive substrate 110 and externally specified memory management priorities communicated through user interface 1010, without compromising the structural integrity of the curvature conservation law enforced by curvature conservation engine 130 or the hallucination resistance properties of four-layer sleep-state gating subsystem 700 across active sector 111, boundary sector 112, and irreversible sector 113 of cognitive substrate 110.

### Exemplary Computing Environment

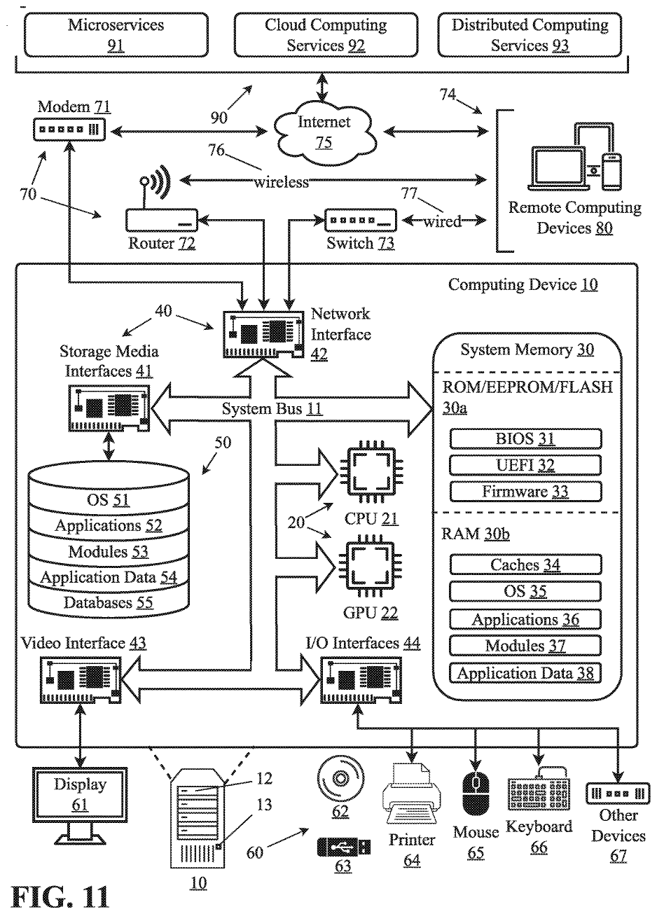

FIG. 11 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system comprising at least one processor, a memory, and a plurality of programming instructions stored in a non-transitory medium that, when operating on the at least one processor, cause the system to:
maintain one or more cognitive substrates, each cognitive substrate comprising a structured geometric space in which proximity corresponds to semantic relatedness and curvature measures local incompatibility, wherein the geometric structure of said substrates persists across interactions and is reshaped by use rather than reset;
decompose each cognitive substrate into an active sector in which traversal and revisable adaptation occur, an irreversible sector comprising one or more irreversible reservoirs, and a boundary sector mediating curvature exchange between the active sector and the irreversible sector;
enforce a curvature conservation constraint providing that total curvature energy across the active sector, boundary sector, and irreversible sector changes only in response to externally introduced experience;
transition from an active cognitive mode to a sleep mode in which generation of externally directed output is gated and in which the cognitive substrate is subjected to offline operations decoupled from active inference;
select, during said sleep mode, one or more stored cognitive trajectories, memory basins, or compressed geometric structures within the active sector for offline processing;
produce candidate modified structures by applying one or more of the following operations to the selected structures: replay, stochastic perturbation, recombination, compression, generalization, pruning, temporal rewriting, and topological restructuring;
evaluate each candidate modified structure for admissibility by determining whether said structure is compatible with the curvature conservation constraint and with accumulated irreversible constraints of the irreversible sector; and
consolidate candidate modified structures that satisfy admissibility into durable geometric form and suppress or route into the irreversible sector as abstract constraint artifacts those candidate modified structures that fail admissibility evaluation, such that upon resuming the active cognitive mode the cognitive substrate reflects a combined result of the sleep mode operations and future cognitive trajectory routing within said substrate is altered by the combined result.

2. The system of claim 1, wherein the programming instructions further cause the system to operate the sleep mode in selectable maintenance regimes comprising one or more of:
a consolidation-heavy regime in which the primary objective is energetically forced export of curvature from the active sector to the irreversible sector;
a compression-heavy regime in which the primary objective is collapsing redundant cognitive trajectories and semantically diffuse regions into compressed geometric representations;
an exploratory dreaming regime in which the primary objective is generative perturbation and recombination of stored structures to produce candidate novel geometric relationships;
a repair regime in which the primary objective is identifying and resolving contradictions between consolidated reservoirs and active sector structure; and
a domain-maintenance regime in which operations are governed by domain-specific policies specifying which regions of the cognitive substrate may be generalized, promoted, compressed, or preserved.

3. The system of claim 1, wherein the programming instructions further cause the system to perform temporal manifold rewriting during the sleep mode by:
identifying stored cognitive trajectories, path histories, temporal snapshots, or trajectory anchors accumulated during the active cognitive mode;
reconstructing one or more of said stored trajectories against the current geometric structure of the cognitive substrate;
applying one or more of: geometric rewriting of path structure, merging of semantically proximate trajectories, splitting of divergent trajectory bundles, re-anchoring of trajectory endpoints, abstraction of repeated traversal patterns, or erasure of trajectories failing admissibility evaluation; and
updating temporal relationships among memory basins to reflect the rewritten trajectory geometry, such that future cognitive traversals within the substrate are routed according to the updated temporal structure rather than the originally recorded structure.

4. The system of claim 3, wherein the programming instructions further cause the system to preserve, during temporal manifold rewriting, cognitive trajectories exhibiting high curvature-recall value by reinforcing the geometric structure of said trajectories rather than abstracting or erasing said trajectories, such that said trajectories remain accessible to future active-mode traversal at reduced energetic cost.

5. The system of claim 1, wherein the programming instructions further cause the system to evaluate candidate modified structures for admissibility through a set of sleep-phase admissibility gates comprising:
a compatibility gate that determines whether the candidate modified structure is geometrically compatible with existing irreversible reservoirs of the irreversible sector;
a coherence gate that determines whether the epistemic curvature of the candidate modified structure satisfies a phase criterion derived from holonomy of an epistemic connection on the cognitive substrate; and
a capacity gate that determines whether absorption of the candidate modified structure into the irreversible sector would exceed available exchange capacity at the relevant reservoir boundary;
wherein a candidate modified structure is admitted to durable consolidation only upon non-blocking assessment from all of said gates.

6. The system of claim 1, wherein the programming instructions further cause the system to perform curation and compression operations during the sleep mode by:
identifying pairs or groups of stored cognitive trajectories exhibiting redundant geometric structure;
collapsing said redundant trajectories into generalized geometric templates representing the shared structure while releasing the individual trajectory representations from the active sector;
compressing regions of the cognitive substrate exhibiting low traversal frequency or high semantic diffuseness by reducing local curvature resolution in said regions; and
promoting reusable geometric abstractions identified during compression into durable structures assigned to a long-term memory tier of the cognitive substrate.

7. The system of claim 1, wherein the programming instructions further cause the system to perform dreaming as controlled perturbation and recombination during the sleep mode by:
generating dream candidates through one or more of: stochastic perturbation of stored geometric structures, interpolation among semantically related trajectory bundles, speculative path extension beyond recorded trajectory endpoints, bridge formation across geometrically disconnected regions of the cognitive substrate, and hypothetical reconstruction of partially degraded memory basins; and
subjecting each dream candidate to admissibility evaluation before allowing said candidate to influence the durable geometric structure of the cognitive substrate, such that generative offline exploration is bounded by structural epistemic control governed by the curvature conservation constraint.

8. The system of claim 1, wherein the programming instructions further cause the system to route candidate modified structures produced during the sleep mode into differentiated persistence channels comprising:
a consolidation channel through which candidate modified structures satisfying admissibility are strengthened and integrated into the irreversible sector as durable cognitive content;
a quarantine channel through which candidate modified structures that are provisionally plausible but not yet corroborated are retained in the active sector under suppressed traversal weight pending further evaluation during a subsequent sleep mode or active mode operation; and
a constraint deposition channel through which candidate modified structures that fail admissibility evaluation are transformed into abstract suppression artifacts and deposited into the irreversible sector, wherein said artifacts constrain future admissibility without introducing navigable content into any irreversible reservoir.

9. The system of claim 8, wherein the programming instructions further cause the system to, upon detecting that a candidate modified structure is contradictory with respect to a consolidated irreversible reservoir, initiate localized revision of said reservoir through a reflux channel at an energetic cost substantially exceeding the barrier energy of said reservoir, confining said revision to the minimal region of the reservoir geometry required to resolve the detected contradiction.

10. The system of claim 1, wherein the programming instructions further cause the system to perform memory basin maintenance during the sleep mode by:
executing policy-driven reentry into one or more selected memory basins within the cognitive substrate;
reinforcing the geometric structure of each selected memory basin by traversing cognitive trajectories entering said basin, thereby deepening curvature-defined basin boundaries and increasing the stability of future path routing toward said basin; and
selectively promoting repeatedly reinstantiated memory basins to a protected tier of the cognitive substrate in which said basins are resistant to compression, pruning, or erasure during subsequent sleep mode operations.

11. The system of claim 1, wherein the programming instructions further cause the system to receive one or more user-specified memory reinforcement designations and, in response, during the sleep mode, apply additional traversal and curvature reinforcement to the cognitive trajectories and memory basins corresponding to said designations and lock said trajectories and basins against pruning or compression operations unless explicitly overridden by a subsequent user designation or control policy.

12. The system of claim 1, wherein the programming instructions further cause the system to shape sleep mode operations according to one or more control policies specifying one or more of:
a permitted generalization scope defining which regions of the cognitive substrate may be abstracted during the sleep mode;
a fidelity threshold defining a minimum geometric preservation metric that compressed or rewritten structures must satisfy to be retained;
a recency bias parameter weighting recently recorded cognitive trajectories relative to older trajectories during pruning decisions; and
a domain-specific preservation mandate designating particular cognitive substrate regions as exempt from compression, pruning, or temporal rewriting.

13. The system of claim 1, wherein the programming instructions further cause the system to generate, during the sleep mode, one or more experimental branch substrates sandboxed from the canonical cognitive substrate, wherein:
dream candidates and reconstructed trajectory variants are evaluated within said experimental branch substrates rather than directly within the canonical cognitive substrate;
modifications within said experimental branch substrates that satisfy admissibility evaluation at the conclusion of the sleep mode are selectively merged into the canonical cognitive substrate; and
modifications within said experimental branch substrates that fail admissibility evaluation are discarded without altering the geometric structure of the canonical cognitive substrate.

14. The system of claim 1, wherein the programming instructions further cause the system to resume the active cognitive mode from the sleep mode by:
computing a post-sleep manifold update that propagates structural changes resulting from sleep mode operations throughout the active sector of the cognitive substrate;
updating path routing weights throughout the cognitive substrate to reflect the modified geometric structure; and
qualifying subsequent active-mode cognitive output based on whether the cognitive trajectories generating said output traverse regions of the cognitive substrate that were modified, consolidated, revised, or suppressed during the sleep mode.

15. The system of claim 1, wherein the programming instructions further cause the system to schedule entry into the sleep mode based on one or more of:
a detected cessation or reduction in externally directed inference demand;
an accumulated curvature load in the active sector exceeding a maintenance threshold derived from the curvature conservation constraint;
an elapsed structural time measure reflecting accumulated irreversible commitments since a prior sleep mode; and
an externally imposed maintenance schedule specifying sleep mode entry intervals or durations.

16. The system of claim 6, wherein the programming instructions further cause the system to, upon completing compression and promotion operations during the sleep mode, transmit to one or more remote persistent cognitive machine instances geometric abstractions that satisfy admissibility and have been promoted to the long-term memory tier, while withholding from said transmission all non-promoted trajectories, provisional structures, and unresolved curvature, such that inter-instance synchronization is limited to consolidated and admissible abstracted content.

17. A non-transitory computer-readable medium storing a plurality of programming instructions that, when executed by at least one processor, cause a system to:
maintain one or more cognitive substrates, each cognitive substrate comprising a structured geometric space in which proximity corresponds to semantic relatedness and curvature measures local incompatibility, and wherein the geometric structure of said substrates persists across interactions and is reshaped by use rather than reset;
decompose each cognitive substrate into an active sector in which traversal and revisable adaptation occur, an irreversible sector comprising one or more irreversible reservoirs, and a boundary sector mediating curvature exchange between the active sector and the irreversible sector;
enforce a curvature conservation constraint providing that total curvature energy across the active sector, boundary sector, and irreversible sector changes only in response to externally introduced experience;
transition from an active cognitive mode to a sleep mode in which generation of externally directed output is gated and in which the cognitive substrate is subjected to offline operations decoupled from active inference;
select, during said sleep mode, one or more stored cognitive trajectories, memory basins, or compressed geometric structures within the active sector for offline processing;
apply to said selected structures one or more of: replay, stochastic perturbation, recombination, compression, generalization, pruning, temporal rewriting, or topological restructuring, thereby producing candidate modified structures;
evaluate each candidate modified structure for admissibility by determining whether said structure is compatible with the curvature conservation constraint and with accumulated irreversible constraints of the irreversible sector; and
consolidate candidate modified structures that satisfy admissibility into durable geometric form and suppress or route into the irreversible sector as abstract constraint artifacts those candidate modified structures that fail admissibility evaluation, such that upon resuming the active cognitive mode the cognitive substrate reflects a combined result of the sleep mode operations and future cognitive trajectory routing within said substrate is altered by the combined result.
